(19) United States
(12) Patent Application Publication
(10) Pub. No.: US 2026/0263963 A1
(43) Pub. Date: Sep. 10, 2026

(54) ROBUST ABLATION PRODUCTION OF GAS-PHASE ATOMS AND MOLECULES

(71) Applicant: California Institute of Technology, Pasadena, CA (US)

(72) Inventors: Nicholas R. Hutzler, Pasadena, CA (US); Chandler J. Conn, Pasadena, CA (US); Madison I. Howard, Pasadena, CA (US); Yuxi Yang, Pasadena, CA (US); Phelan Yu, Pasadena, CA (US)

(73) Assignee: California Institute of Technology, Pasadena, CA (US)

(21) Appl. No.: 19/551,368

(22) Filed: Feb. 26, 2026

Related U.S. Application Data
(60) Provisional application No. 63/767,917, filed on Mar. 6, 2025.

(51) Int. Cl. B01D 7/00

(52) U.S. Cl. CPC B01D 7/00

(57) ABSTRACT

Methods of forming gas phase atoms or molecules includes providing a solid material; forming a viscous mixture that includes a solid material, a solvent, and at least one acid; drop casting the viscous mixture onto a substrate; forming a volumetrically distributed mixture on the substrate; evaporating a liquid fraction of the solvent from the volumetrically distributed mixture to form a volumetrically distributed target on the substrate; ablating a portion of the volumetrically distributed target on the substate with a laser; and forming the gas phase atoms or molecules. The method can include adding at least one polyol to the viscous mixture.

### CROSS-REFERENCES TO RELATED APPLICATIONS

This application claims priority to U.S. Provisional Patent Application No. 63/767,917, filed on Mar. 6, 2025, entitled “Robust Ablation Production of Gas-Phase Atoms and Molecules,” the disclosure of which is hereby incorporated by reference in its entirety for all purposes.

### STATEMENT AS TO RIGHTS TO INVENTIONS MADE UNDER FEDERALLY SPONSORED RESEARCH AND DEVELOPMENT

This invention was made with government support under Grant No. PHY2309361 awarded by the National Science Foundation. The government has certain rights in the invention.

The disclosure of “Production and Spectroscopy of Cold Radioactive Molecules,” Chandler J. Conn, Phelan Yu, Madison I. Howard, Yuxi Yang, Chaoqun Zhang, Arian Jadbabaie, Aikaterini Gorou, Alyssa N. Gaiser, Timothy C. Steimle, Lan Cheng, Nicholas R. Hutzler, arXiv: 2508.08368, Aug. 11, 2025, is also hereby incorporated by reference in its entirety for all purposes.

### BACKGROUND OF THE INVENTION

Production of gas-phase atoms and molecules is the initial step for many applications in materials science, device fabrication, quantum information science, chemical analysis, chemical synthesis, and more. The species of interest usually have very low vapor pressure at room temperature, which forces them to be made initially via some energetic process, followed by further cooling if needed. Common approaches include using effusive ovens, atomic dispensers, thermal or thermo-chemical production, or laser ablation.

Despite the progress made in the area of gas-phase atoms, there is a need in the art for improved methods and systems related to the production of gas-phase atoms and molecules.

### SUMMARY OF THE INVENTION

Embodiments of the present invention relate to production of stable atoms or molecules. More particularly, embodiments of the present invention provides methods and systems for forming cold gaseous phase atoms or molecules from exotic species such as radioactive nuclei. The present invention is applicable for reliably forming gas phase atoms or molecules for sub microgram quantities of starting materials.

A particular embodiment provides a method of embedding micrograms of a predetermined species of atom or molecule, for example, radium, in a matrix to produce a mechanically stable, repeatable, and robust ablation source and using laser ablation to create cold, gas phase radium atoms with high efficiency.

As described herein, an embodiment of the present invention provides methods useful for producing the gas phase atoms or molecules. In a particular embodiment, the method includes providing a solid material, forming a viscous mixture that includes the solid material, a solvent, at least one acid (for example, hydrochloric acid or nitric acid), and at least one polyol, drop casting the viscous mixture onto a substrate, forming a volumetrically distributed mixture on the substrate, evaporating a liquid fraction of the solvent from the volumetrically distributed mixture to form a volumetrically distributed target on the substrate, ablating a portion of the volumetrically distributed target on the substrate with a laser, and forming the gas phase atoms or molecules. In some embodiments, the drop casting can include adding from 0.5 μL to 5 μL of the viscous mixture onto a top surface of the substrate. In yet other embodiments, the method can further include positioning the volumetrically distributed target on the substrate in a cell including an inert gas, and cooling the substrate in the cell including the inert gas to cryogenic temperatures prior to ablating the portion of the volumetrically distributed target on the substrate. In some embodiments, the viscous mixture can have a viscosity of from 1 mPa/s to 10,000 mPa/s. In some embodiments, the solid material can include an organic or metal salt. In some embodiments, the metal salt can include radium nitrate, radium chloride, barium chloride, or barium nitrate and can added to the viscous mixture in an amount from 0.1 micrograms to 20,000 micrograms. In some embodiments, the at least one acid can be nitric acid or hydrochloric acid. In yet other embodiments, the polyol can include xylitol, lactitol, sorbitol, erythritol, arabitol, ribitol, or a combination thereof. In some embodiments, the substrate can be aluminum hydroxide, copper, gold, silica aerogel, alumina, quartz frit, surface with electroplated gold, Inconel, Hastelloy, or silicon carbide.

According to another embodiment of the present invention, a method of producing gas phase atoms or molecules is provided. In a particular embodiment, the method includes providing a solid material, forming a viscous mixture that can include a solvent, at least one acid, drop casting the viscous mixture onto porous alumina, distributing the viscous mixture throughout the porous alumina, evaporating the solvent from the viscous mixture to form a volumetrically distributed target inside the porous alumina, ablating the target volume with a laser, and forming the gas phase atoms or molecules. In some embodiments, the film can have a substantially uniform thickness and composition. In some embodiments, the porous alumina can have a porosity of at least 30%. In some embodiments, the liquid solution can include from 0.1 to 20,000 μg of the solid material. In yet other embodiments, the solvent can include water. In some embodiments, the solid material can be a metal salt, including but to limited to, radium chloride, radium nitrate, barium chloride, or barium nitrate. In some embodiments, the solid material can be an organic salt. In some embodiments, the can include a step of positioning the film on the porous alumina in a cell and evacuating the cell to a pressure in a range of 1×10⁻⁴ torr to 1×10⁻¹³ torr.

Such methods open up novel avenues for forming cryogenic gaseous samples of atoms and molecules for spectroscopy and fundamental physics research applications. These methods could be used with little modification as sources for any application needing gas-phase atoms and molecules, including materials science applications, device fabrication, chemical analysis and synthesis, field sensing, and quantum information processing platforms. This method could also be used for chemical and spectroscopic analysis of samples, especially for the analysis of trace impurities; since the apparatus works at cryogenic temperatures and offers high spectroscopic resolution, this could be used for isotopic analysis as well.

Numerous benefits are achieved by way of the present disclosure over conventional techniques. For example, the methods and systems described herein open up novel avenues for forming cryogenic gaseous samples of atoms and molecules for spectroscopy and fundamental physics research applications. These methods can be used with little modification as sources for any application needing gas-phase atoms and molecules, including materials science applications, device fabrication, chemical analysis and synthesis, field sensing, and quantum information processing platforms. The methods described herein can also be used for chemical and spectroscopic analysis of samples, especially for the analysis of trace impurities. Since the apparatus works at cryogenic temperatures and offers high spectroscopic resolution, the methods and systems described herein can be useful for isotopic analysis as well.

Moreover, the intentional inclusion of a polyol in the solution is an extremely important technological milestone that can enable suppression of the coffee ring effect observed in drop casting, thereby providing a consistent source for production of gaseous atoms and molecules from microscopic amounts of starting materials. These and other embodiments of the disclosure, along with many of its advantages and features, are described in more detail in conjunction with the text below and corresponding figures.

### BRIEF DESCRIPTION OF THE DRAWINGS

FIG. 1A is a simplified schematic diagram illustrating a closed-cycle cryocooler system including a cryogenic buffer gas cell according to an embodiment of the present invention.

FIG. 1B is a simplified schematic diagram illustrating the cryogenic buffer gas cell including a target plate according to an embodiment of the present invention.

FIG. 1C is a simplified schematic diagram of an example target plate including a pure metal attached to the center of the target plate and optional reagents positioned around the pure metal according to embodiments of the present invention.

FIG. 2A is a simplified flow chart illustrating a method of producing gas-phase atoms or molecules using systems and reagents according to an embodiment of the present invention.

FIG. 2B is a simplified flow chart illustrating a method of producing gas-phase atoms or molecules using systems and reagents according to an embodiment of the present invention.

FIG. 2C is a simplified flow chart illustrating a method of producing gas-phase atoms or molecules using systems and reagents according to an embodiment of the present invention.

FIG. 3A is a plot illustrating the spatial distribution of ablation spots and the integrated number of atoms vaporized for Radium on an alumina substrate according to an embodiment of the present invention.

FIG. 3B is a plot illustrating the spatial distribution of ablation spots and the integrated number of atoms vaporized for Barium on an alumina substrate according to an embodiment of the present invention.

FIG. 3C is a plot illustrating the spatial distribution of ablation spots and the integrated number of atoms vaporized for Radium on an alumina substrate according to an embodiment of the present invention.

FIG. 4A is a photograph depicting the surface structure for the target compounds following evaporation and heating according to an embodiment of the present invention.

FIG. 4B is a photograph depicting an alternate view of FIG. 4A showing the relative height of bubbling observed for the target compounds following evaporation and heating according to an embodiment of the present invention.

FIG. 5A is an image illustrating deposition of a translucent gel on the center of a pure metal substrate positioned on a target plate according to an embodiment of the present invention.

FIG. 5B is a simplified plot of a raster scan of the ablated target surface showing a concentration of atoms found in the translucent gel according to an embodiment of the present invention.

FIG. 5C is a plot depicting the optical density per shot (optical density (OD)=−ln(T) for transmission T) with respect to ablation shot number according to an embodiment of the present invention.

FIG. 5D is a plot of the estimated mass fraction of the target that has been used based on rate of depletion per shot according to an embodiment of the present invention.

FIG. 6 is a plot of the fluorescence of radium-226 monofluoride (RaF) taken on the RaF

$${X}^{2} {Σ}_{1 / 2}^{+} ( {v}^{″} = 1 ) - {C}^{2} {Σ}_{1 / 2}^{+} ( {v}^{″} = 0 )$$

transition using pulsed dye excitation while ablating a pressed powder CuF₂ co-target according to an embodiment of the present invention.

FIG. 7 is a simplified schematic illustrating the critical points on the potential energy surface of Ra+H₂O according to an embodiment of the present invention.

FIG. 8A is a plot showing the low-resolution survey of RaOH according to an embodiment of the present invention.

FIG. 8B is a plot of a highlighted region from FIG. 8A showing the early-time fluorescence due to non-resonant glow when the laser is unblocked through the cell or switched between blocked and unblocked according to an embodiment of the present invention.

FIG. 8C is a plot of a highlighted region from FIG. 8A showing the early-time fluorescence due to non-resonant glow when the laser is unblocked through the cell or switched between blocked and unblocked according to an embodiment of the present invention.

FIG. 8D is a plot of the background subtracted signal in FIG. 8B emphasizing the excess fluorescence present at early time when the laser is resonant and passing through the cell according to an embodiment of the present invention.

FIG. 8E is a plot of the background subtracted signal in FIG. 8C emphasizing the excess fluorescence present at early time when the laser is resonant and passing through the cell according to an embodiment of the present invention.

FIG. 9A is a plot illustrating the medium-resolution (about 0.07 cm⁻¹) pulsed dye spectrum identifying the band head and coarse features relative to the RaOH \tilde{X}-\tilde{C} origin according to an embodiment of the present invention.

FIG. 9B is a plot illustrating the high-resolution spectrum of the low-N region, identifying the 31 lines used in the Hamiltonian fit according to an embodiment of the present invention.

FIG. 9C is a plot illustrating the R-branch N″=6 doublet of FIG. 9B and overlaid by the Voigt fits that were used to extract line centers according to an embodiment of the present invention.

FIG. 9D is a simplified plot illustrating histograms of RaOD fluorescence signals while ablating hydroxide and deuteroxide co-targets according to an embodiment of the present invention.

FIG. 10 is a series of plots illustrating two-dimensional F-test statistical confidence regions for selected parameters in the RaOH

$${\tilde{X}}^{2} {Σ}_{1 / 2}^{+} - {\tilde{C}}^{2} {Σ}_{1 / 2}^{+}$$

high-resolution effective Hamiltonian fit according to an embodiment of the present invention.

FIG. 11 is a plot illustrating the relative heights of the ^{P}P₁₁(1) and ^{P}Q₁₂(1) lines as a function of the total dipole moment (TDM) ratio T_{±1}/T₀ according to an embodiment of the present invention.

FIG. 12A is a plot illustrating an optical plot density trace during ablation of a spot on the drop-casted target according to an embodiment of the present invention.

FIG. 12B is a plot illustrating an optical plot density trace during ablation of the same spot in FIG. 12A according to an embodiment of the present invention.

FIG. 12C is a plot illustrating the normalized optical density as a function detuning from the ¹S₀-¹P₁ resonance and time after ablation of the drop-casted target according to an embodiment of the present invention.

FIG. 13A is a plot illustrating the optical density of ¹⁷⁴YbOH performed by driving the \tilde{X}²Σ⁺-Ã²Π_{1/2}^{P}Q₁₂(N″=1) rotational transition according to an embodiment of the present invention.

FIG. 13B is a plot illustrating the estimated molecular photons detected per unit time as compared to FIG. 13A according to an embodiment of the present invention.

FIG. 13C is a plot illustrating the estimated photons detected per unit time obtained from demodulated and background-subtracted RaOH single-frequency fluorescence trace according to an embodiment of the present invention.

FIG. 14A is a simplified schematic of energy band gaps of Radium reacting with water according to an embodiment of the present invention.

FIG. 14B is a plot demonstrating the dependence of radium-226 monohydroxide (RaOH) production enhancement on the ³P₁ laser detuning from resonance according to an embodiment of the present invention.

FIG. 14C is a plot of the single-shot fluorescence demonstrating the successful production of radium-226 monodeuteroxide (RaOD) according to an embodiment of the present invention.

FIG. 15 is a plot illustrating the resonant laser-induced fluorescence of RaOH molecules recorded after ablation while addressing the \tilde{X}²Σ⁺-\tilde{C}²Σ⁺ band system.

FIG. 16A is a plot illustrating a pulsed-dye laser fluorescence spectrum of RaOH (without normalization) at about 2.5 gigahertz (GHz) resolution set by the laser linewidth according to an embodiment of the present invention.

FIG. 16B is a plot illustrating a CW dye laser fluorescence spectrum of RaOH with about 100 megahertz (MHz) linewidth set by the Doppler temperature and radiative broadening according to an embodiment of the present invention.

FIG. 16C is a magnified region of FIG. 16B showing the spin rotation doublet lineshape with a Voigt fit according to an embodiment of the present invention.

FIG. 16D is a plot illustrating a continuous wave (CW) dye laser fluorescence spectrum of RaOD according to an embodiment of the present invention.

FIG. 17 is a plot illustrating a fluorescence spectrum without normalization of the RaF

$${X}^{2} {Σ}_{1 / 2}^{+} ( {v}^{″} = 1 ) - {C}^{2} {Σ}_{1 / 2}^{+} ( {v}^{′} = 0 )$$

vibronic band system, recorded via pulsed dye excitation at Δν about 2.5 GHz laser linewidth according to an embodiment of the present invention.

### DETAILED DESCRIPTION OF SPECIFIC EMBODIMENTS

Radioactive atoms and molecules are sought for use in studying a wide range of physics including nuclear structure, fundamental symmetries, stellar processes, and more. However, limited availability and safety hazards result in difficulties which inhibit every step of their study. For this reason, radioactive molecules remain a relatively unexplored area with many unrealized applications. Recently, there has been great interest in molecules containing heavy, octupole-deformed (“pear-shaped”) nuclei, which amplify sensitivity to nuclear symmetry violations due to new physics by more than three orders of magnitude compared to spherical nuclei. Combined with the roughly thousand-fold enhancement of molecules over atoms, these species are extremely sensitive probes of fundamental nuclear properties and physics beyond the Standard Model (BSM).

Among the possible octupole-deformed candidates, radium-containing molecules are compelling due to the large and relatively well-characterized octupole shape deformation of radium, their large molecular sensitivity to fundamental symmetry violations via a nuclear Schiff moment, and their fairly unique ability to create optically controllable, laser-coolable molecules. By combining modern quantum tools with the significant sensitivity enhancements to BSM physics afforded by molecules containing heavy, deformed nuclei, probing may be achieved far above TeV energy scales, complementing and extending the reach of state-of-the-art colliders and precision measurements.

For precision atomic and molecular experiments, achieving a high degree of motional and internal quantum state control is an essential prerequisite as it enables long interrogation times as well as coherent, quantum state-resolved preparation, manipulation, and readout. Recent approaches have made progress in this direction with radium-containing molecules, including RaF spectroscopy using accelerated radioisotope beam and the trapping of radium-containing polyatomic molecular ions, both with an eye toward precision measurement of fundamental symmetries.

Molecules with heavy, radioactive nuclei promise extreme sensitivity to fundamental nuclear and particle physics. However, these nuclei are available in limited quantities, which challenges their use in precision measurements. As discussed herein, high-resolution laser spectroscopy, cryogenic cooling, and low-background spectroscopic detection methods are employed to produce gas-phase atoms or molecules of radioactive isotopes. The methods and apparatus configurations described herein may be readily applied to a wide range of species and establishes key capabilities for molecular quantum sensing of exotic nuclei.

As described herein, methods and systems are established for the production, cooling, and high-resolution laser spectroscopy of compounds including radium and barium. For example, the radium compounds include, but are not limited to radium-226 monohydroxide, monodeuteroxide, and monofluoride molecules (226RaOH, 226RaOD, and 226RaF) at ~4 K temperatures in a tabletop apparatus. A person of ordinary skill in the art may understand that the compounds including 226RaOH, 226RaOD, and 226RaF were used to demonstrate the applicability of the methods and systems described herein and do not limit the application to these alone.

Using pulsed laser ablation of fabricated radium targets, cryogenic buffer gas cooling, resonant optical driving of state-selective chemical reactions, and high-sensitivity low-background detection methods, cold and stopped samples of gas phase atoms and molecules is possible. These species have structures amenable to laser cooling and optical trapping for long coherence times and high-fidelity quantum state control and readout. The polyatomic species furthermore feature a parity doublet structure which enables advanced protocols for precision measurement and quantum information. The availability of radioactive molecules for tabletop experiments in a university (or larger) setting enables wide-ranging applications in fundamental physics. The methods and systems discussed below allow for the study of small quantities of starting material, such as less than a few micrograms, and can achieve a high yield of gas phase production, previously thought unachievable in modern physics.

Embodiments of the present invention provide methods and systems for producing gas phase atoms or molecules. As an example, the system can include cryogenic source designs, spectroscopic techniques, spectroscopic detection methods, laser ablation methods, and production of gas phase atoms and molecules. In the following description, various embodiments will be described. For purposes of explanation, specific configurations and details are set forth in order to provide a thorough understanding of the embodiments. However, it will also be apparent to one skilled in the art that the embodiments may be practiced in other configurations, or without the specific details. Furthermore, well-known features of the device may be omitted or simplified in order not to obscure the embodiment being described.

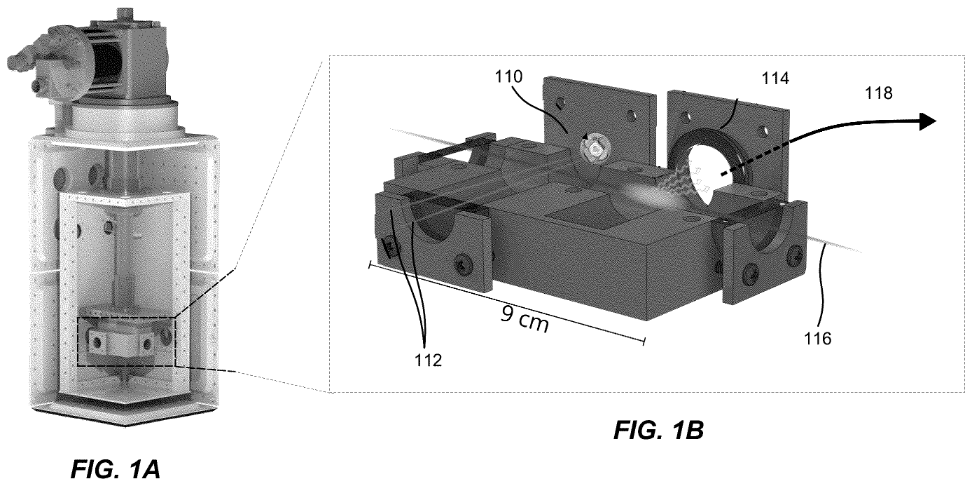

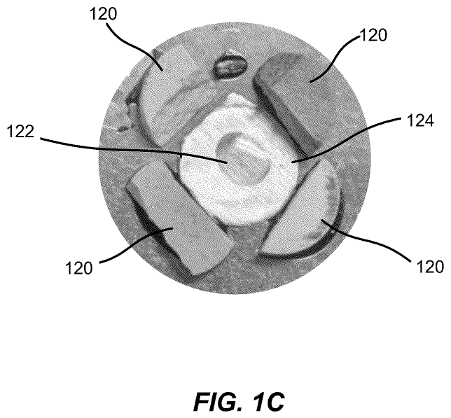

FIG. 1A is a simplified schematic diagram illustrating a closed-cycle cryocooler system including a cryogenic buffer gas cell according to an embodiment of the present invention. In some embodiments, the closed-cycle cryocooler system may be known by those skilled in the art. The cryocooler may be operated at room temperature or may be subsequently cooled during operation to temperatures of liquid helium without the use of cryogens. For example, the cryocooler may be cooled down to a temperature of at least 1 kelvin (K), at least 2 K, at least 3 K, at least 4 K, at least 5 K, at least 6 K, at least 7 K, at least 8 K, at least 9 K, at least 10 K, at least 11 K, at least 12 K, at least 13 K, at least 14 K, at least 15 K, at least 16 K, at least 17 K, at least 18 K, at least 19 K, or at least 20 K. In some embodiments, the cryocooler may be cooled down to a temperature of 1 K to 100 K. For example, the cryocooler may be cooled down to a temperature range of from 1 K to 100 K, from 10 K to 90 K, from 20 K to 80 K, from 30 K to 80 K, from 40 K to 80 K, from 50 K to 80 K, from 60 K to 80 K, from 70 K to 80 K, from 80 K to 100 K, or from 90 K to 100 K. In some embodiments, the cryocooler may be cooled down to a temperature in the range of 4 K to 8 K during operation. The cryocooler may house a cryogenic cell in a central chamber of the cryocooler and may be discussed in more detail in relation FIG. 1B. Thus, in some embodiments, a cryocooler is used because of the technological advantages provided by cooling, for example, to 80 K. However, the methods and systems described herein can also be implemented in a room temperature apparatus with no cryocooling, for example, in some ion trap applications. Thus, cooling is useful for many applications but is not required by embodiments of the present invention to be useful.

FIG. 1B is a simplified schematic diagram illustrating the cryogenic buffer gas cell including a target plate 110 according to an embodiment of the present invention. The buffer gas cell includes a series of apertures to allow ablation lasers 112 to travel into the buffer gas cell and strike the target plate 110. The pulsed ablation lasers 112 vaporize reagents off of the target plate 110, which fill the cell interior and thermalize with cold helium buffer gas. In some embodiments, other inert gases may be employed in the cryocooler. In some embodiments, the method may employ the use of reactive gases to aid in forming a molecule of interest. The gas used in the cryocooler may be selected based on the specific reaction conditions such as the metal salts, organic salts, or acid selected for producing the volumetrically distributed target on the target plate 110. For example, the gas may include helium, neon, hydrogen, or nitrogen. In some embodiments, the gas may be a noble gas. Additional apertures may be configured perpendicularly to the apertures for the ablation lasers 112 to allow the probe/enhancement lasers 116 to pass through a cross-section of the buffer gas cell. The buffer gas cell includes a lens 114 positioned parallel to the target plate 110 but offset by 4 cm. The offset allows for collimated laser-induced fluorescence to be detected 118 by a photomultiplier tube external to the cryostat.

FIG. 1C is a simplified schematic diagram of an example target plate 110 including a pure metal 124 attached to the center of the target plate 110 and optional reagents 120 positioned around the pure metal 124 according to embodiments of the present invention. The target plate 110, including the pure metal 124 provides a surface for the target material 122 to be deposited on the pure metal 124. In some embodiments, the pure metal may be gold, platinum, iridium, tantalum, rhodium, titanium, or other metals that are unreactive or suitably resistant to radioisotopes and acids.

In alternate embodiments, the target plate 110 may include an alternate substrate secured to the target plate 110 for the deposition of the target sample. For example, the substrate may be aluminum hydroxide, copper, silica aerogel (hydrophobic or hydrophilic), alumina of various porosity, non-porous alumina, quartz frit, Inconel, Hastelloy, silicon carbide, or gold electroplated onto copper, nickel, nickel on copper, or gold foil. In some embodiments, the substrate may be used under cryogenic temperatures as described above, at room temperatures, or heated up to 100° C. In some embodiments, the substrate may be selected based on the environmental conditions.

Methods of producing gas phase atoms or molecules are provided herein. The methods of producing the gas phase atoms or molecules may be described in more details below. A person or ordinary skill in the art may understand that steps provided below may be optional, placed in an alternate order, or may be omitted completely.

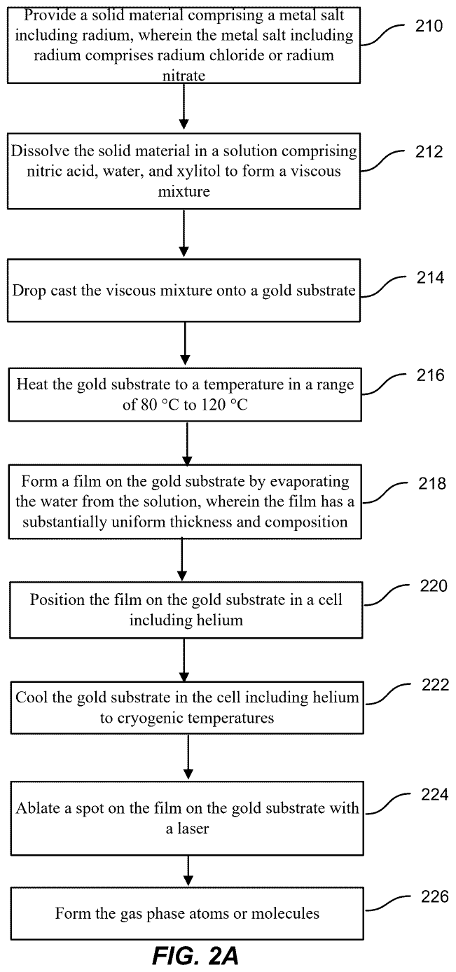

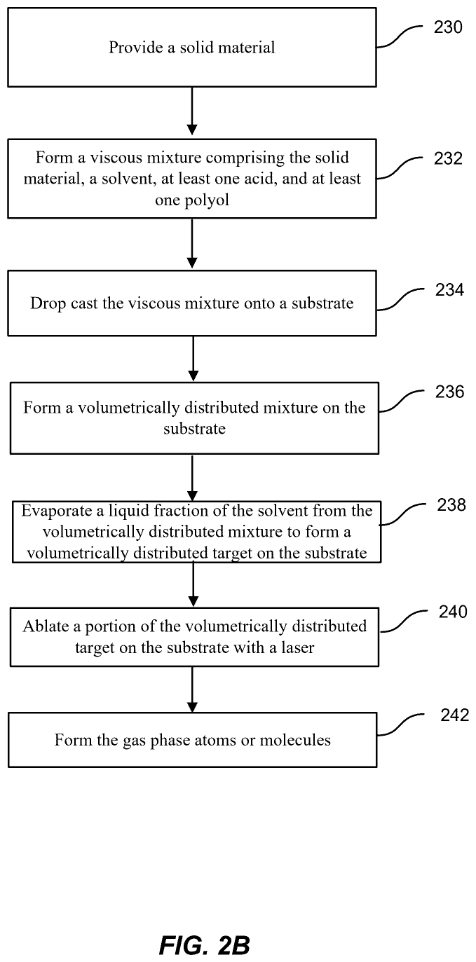

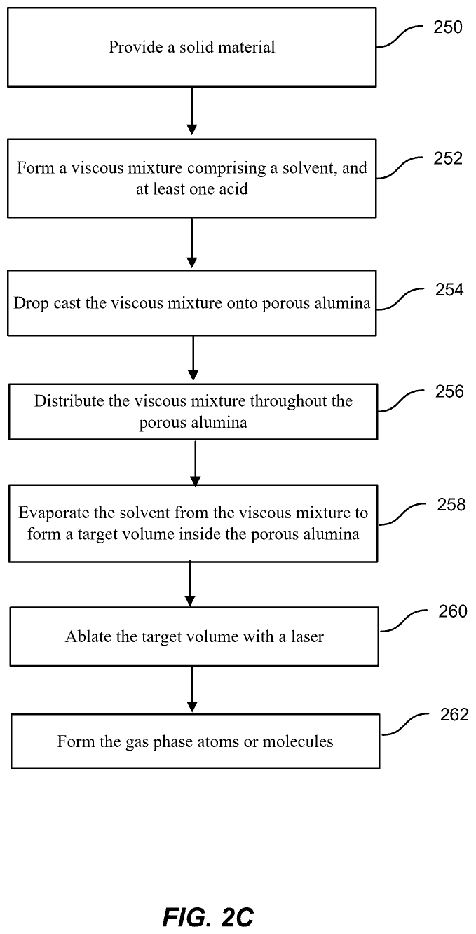

FIG. 2A is a simplified flow chart illustrating a method of producing gas-phase atoms or molecules using systems and reagents according to an embodiment of the present invention. In some embodiments, the method includes providing a solid material that includes a metal salt including radium (210). In some embodiments, the solid material may be a radium salt such as radium nitrate or radium chloride. In other embodiments, the solid material may be rare or isotopically pure materials. In alternative embodiments, rather than starting with a solid material, the method can utilize a solution including the atom of interest, for example, a solution including radium.

Due to the rarity of the solid material (or the material in solution), the method described herein is ideal for forming gas phase atoms or molecules from microgram (μg) quantities of material. In some embodiments, the solid material may be provided in an amount of from 0.1 μg to 20,000 μg. For example, the starting amount of the solid material may be from 0.1 μg to 10,000 μg, from 1 μg to 10,000 μg, from 10 μg to 10,000 μg, from 100 μg to 10,000 μg, from 1 μg to 20,000 μg, from 10 μg to 20,000 μg, from 100 μg to 20,000 μg, from 0.1 μg to 1,000 μg, from 0.1 μg to 100 μg, or from 0.1 μg to 10 μg.

In some embodiments, the method includes dissolving the solid material in a solution including nitric acid, water, and xylitol to form a viscous mixture (212). In some embodiments, the nitric acid may be at a final concentration of from about 0.05 M to 0.50 M. The weak acid may be added to help prevent the metal ions, such as radium, from adhering to a container while in solution. In embodiments that utilize a solution rather than a solid material, forming the viscous mixture can include mixing the solution including the atom of interest with an additional solvent or more of the solvent in the solution including the atom of interest, the weak acid, and the xylitol.

The xylitol may be used in the methods described herein due to its unique ability to not undergo a phase transition or caramelization during heating. Thus, in contrast with sugars, sugar alcohols as utilized herein suppress the polymerization process resulting in caramelization of sugars. Additionally, the use of xylitol as an additive enables the use of these additives at lower concentrations. In particular, since the viscous mixture is formed as a volume rather than as a layer over a surface, the concentration of radium in the volume is reduced, thereby reducing the impact of radiolytic chemical reactions between the viscous mixture and the substrate produced by the radiation emitted from the radium.

For example, the xylitol utilized in solution facilitates the uniform distribution of dissolved solid material during the evaporation of water and may allow for a more consistent and repeatable target site by disrupting the formation of salt crystals. In some embodiments, the xylitol may be added to the solution in a final concentration of from 1 mM to 10 mM. For example, the concentration of polyol in solution may be 1 mM, 2 mM, 3 mM, 4 mM, 5 mM, 6 mM, 7 mM, 8 mM, 9 mM, or 10 mM. In some embodiments, the concentration of xylitol may be greater than 10 mM. For example, the concentration may be up to 1,000 mM.

In some embodiments, the viscous mixture may have a viscosity of from 1 mPa/s to 10,000 mPa/s mPa/s. For example, the viscosity can be from 1 mPa/s to 10,000 mPa/s, from 1 mPa/s to 1000 mPa/s, from 1 mPa/s to 100 mPa/s, or from 1 mPa/s to 10 mPa/s. In some embodiments, the viscosity can be 1 mPa/s, 2 v, 3 mPa/s, 4 mPa/s, 5 mPa/s, 6 mPa/s, 7 mPa/s, 8 mPa/s, 9 mPa/s, 10 mPa/s, or greater than 10 mPa/s. In some embodiments, the viscosity can be 10 mPa/s, 20 mPa/s, 30 mPa/s, 40 mPa/s, 50 mPa/s, 60 mPa/s, 70 mPa/s, 80 mPa/s, 90 mPa/s, 10 mPa/s. In further embodiments, the viscosity can be from 1 mPa/s to 1500 mPa/s when in a liquid state. In some embodiments, in a dried state, the viscosity can be from 1000 mPa/s to 1×10⁶ mPa/s. In some embodiments, the viscosity solution can be 8.92 mPa/s.

Additionally, due to the low amounts of starting material, the total volume of the viscous mixture may be from 1 μL to 100 μL. For example, the starting volume of solution may be from 1 μL to 100 μL, 10 μL to 100 μL, or from 50 μL to 100 μL. In some embodiments, the total volume of viscous mixture may be greater than 100 μL when scaled to industrial levels.

After production of the viscous solution, the solution is drop-cast onto the substrate surface (214). Drop casting, in its simplest form is a straightforward technique used to deposit a liquid solution containing functional materials onto a solid substrate. A droplet of the solution is placed on the surface, and as the solvent evaporates, it leaves behind a volumetrically distributed target or coating of the material. During the drop casting process, the solution prepared is pipet onto the surface of the target plate. In some embodiments, the step of drop casting may include adding about 0.5 μL to 5 μL of viscous solution to the substrate surface. For example, 0.5 μL, 1 μL 1.5 μL, 2.0 μL, 2.5 μL, 3.0 μL, 3.5 μL, 4.0 μL, 4.5 μL, or 5.0 μL may be added to the substrate surface. In examples using Radium, such as the ones described below, the drop-cast solution may include from 10 to 50 μCi of radium. The 50 μCi sample of radium-226 may contain roughly 221 nmol or about 10¹⁷ atoms of radium-226 that may produce a usable number of atoms for 10³ to 10⁴ ablation shots. In some embodiments, the method described herein may employ a larger number of ablation shots with a reduced number of usable atoms produced per shot. For example, the method may employ a laser intensity for producing from 10 to 10¹⁵ usable atoms per shot. For example, the number of usable atom produced per ablation shot may be 10¹, 10², 10³, 10⁴, 10⁵, 10⁶, 10⁷, 10⁸, 10⁹, 10¹⁰, 10¹¹, 10¹², 10¹³, 10¹⁴, or 10¹⁵ usable atoms per ablation shot. In some embodiments, the number of ablation shots may be from 10³ to 10¹⁶. For example, the method may include 10³, 10⁴, 10⁵, 10⁶, 10⁷, 10⁸, 10⁹, 10¹⁰, 10¹¹, 10¹², 10¹³, 10¹⁴, 10¹⁵, or 10¹⁶ ablation shots.

Optionally, the method may include adding a co-target to the target plate as shown in FIG. 1C. The co-target may include ligand-containing species, hydroxide species, deuteroxide species, fluoride species, ytterbium (Yb) species, or other acids. For example, the compounds may be copper hydroxide, aluminum hydroxide, aluminum deuteroxide, aluminum hydroxide doped with Yb powder, telluric acid, boric acid, iron hydroxide, copper fluoride, or aluminum fluoride in combination with driving the metal atom to an electronic state with a resonant laser. The co-targets are produced into solid pellets formed by hydraulic pressing of the powder and adhering the pellet to the target plate positioned around the pure metal substrate. The co-target is ablated 10 ms before the volumetrically distributed target, filling the cell volume with a reagent cloud and desorbing helium to aid with thermalization and diffusion. In some embodiments, the co-target is ablated from 5 ms to 50 ms before ablation of the volumetrically distributed target.

Following drop casting, the target plate, including gold, is heated to a temperature in a range of from 80° C. to 120° C. (216) forming a volumetrically distributed target of material (e.g., a thin film) by evaporating (218) a liquid portion of the sample leaving behind a volumetrically distributed target on the substrate surface. In some embodiments, the gold substrate may be substituted with aluminum hydroxide, copper, silica aerogel (hydrophobic or hydrophilic), alumina of various porosity, non-porous alumina, quartz frit, Inconel, Hastelloy, silicon carbide, or gold electroplated onto copper, nickel, nickel on copper, or gold foil. The substrate surface may include a thin material attached to the substrate. For example, a pure metal such as gold, platinum, iridium, tantalum, rhodium, titanium, or other metals that are unreactive or suitably resistant to radioisotopes and acids.

Upon evaporation of the liquid from the viscous solution, the addition of xylitol provides the added benefit of forming a uniform distribution of the target material throughout the dried volumetrically distributed target. Due to the increased viscosity, the volumetrically distributed target may have a uniform thickness. For example, the volumetrically distributed target may have a three-dimensional structure having a height along the Z-axis ranging from 0.01 μm to 10 μm, depending on the final viscosity and overall dispersion of the solution onto the substrate surface. The more uniform spatial distribution of the target material allows for different target areas to behave more predictably from spot-to-spot allowing for consistent production of gas phase atoms from one ablation spot to the next. Additionally, the viscous solution, due to the added xylitol, distributes the target material over a volume of a material rather than a surface resulting in more useful shots at a particular laser focus shot. The methods described herein allow for hundreds to thousands of useful ablation shots before needing to move the laser focus and it does not require adding any additives and can therefore be more suitable for situations requiring highly reactive chemicals or where high purity is a concern.

As the solution is dried, forming this 3-dimensional structure, the solid support, having the 3-dimensional structure positioned on the top surface, is positioned in a cell including helium gas (220). The cryogenic buffer gas cell is described with respect to FIG. 1B, above. The buffer gas cell is subsequently inserted into the cryocooler. In some embodiments, the cryocooler is subsequently cooled down to cryogenic temperatures (222). In some embodiments, the solid support, having the 3-dimensional structure positioned on the top surface may be placed in an ultrahigh vacuum. For example, using an ion trap approach, the dried solution may be installed in an ultrahigh vacuum chamber without a buffer gas. In some embodiments, the methods described herein may be performed at room temperature without the use of a cryocooler apparatus. In some embodiments, the methods described herein may state, initially, at room temperature, and may be cooled to cryogenic temperatures during the method.

Once the cryocooler is sealed, and the cell is brought to the proper pressure and temperature, the target spot may be ablated using a laser. In some embodiments, the laser may be a pulsed laser of a continuous wave laser. In some embodiments, the ablation parameters depend on the material and substrate. In one non-limiting example, the laser may be a Nd:YAG laser. In some embodiments, the method may include using more than one Nd:YAG laser. For example, the system may use 2 Nd:YAG lasers emitting light at 532 nm with a pulse duration of about 10 nanoseconds (ns) and having a beam diameter of about 1 centimeter (cm). In some embodiments, the beam diameter may be from 5 mm to about 10 mm. for example, the beam diameter may be 5 mm, 5 mm, 7 mm, 8 mm, 9 mm, or 10 mm.

The laser is positioned external to the cryocooler having a focal lens positioned between the cryocooler and the laser to focus the beams onto the target plate. In some embodiments, the focal length lens may have a focal length of from 100 mm to 400 mm. For example, the focal length may be 100 mm, 200 mm, 300 mm, or 400 mm. Furthermore, the laser ablation energy may be from 5 mJ/pulse to 50 mJ/pulse. For example, the laser ablation energy may be 5 mJ/pulse, 10 mJ/pulse, 15 mJ/pulse, 20 mJ/pulse, 25 mJ/pulse, 30 mJ/pulse, 35 mJ/pulse, 40 mJ/pulse, 45 mJ/pulse, or 50 mJ/pulse.

In some embodiments, the substrate may be ablated from 10 to 10,000 times in a single spot before the target sample is depleted. For example, the same spot may be ablated 10 times, 20 times, 30 times, 40 times, 50 times, 60 times, 70 times, 80 times, 90 times, 100 times, 200 times, 300 times, 400 times, 500 times, 600 times, 700 times, 800 times, 900 times, 1000 times, 2000 times, 3000 times, 4000 times, 5000 times, 6000 times, 7000 times, 8000 times, or 9000 times, or 10000 times before the sample is completely depleted and the laser spot need be repositioned. In some embodiments, the method may include reducing the pulse energy of the laser to reduce the number of atoms produced per shot.

The laser ablation of the sample may result in production of gas phase atoms or molecules (226).

It should be appreciated that the specific steps illustrated in FIG. 2A provide a particular method of producing gas-phase atoms or molecules using systems and reagents according to an embodiment of the present invention. Other sequences of steps may also be performed according to alternative embodiments. For example, alternative embodiments of the present invention may perform the steps outlined above in a different order. Moreover, the individual steps illustrated in FIG. 2A may include multiple sub-steps that may be performed in various sequences as appropriate to the individual step. Furthermore, additional steps may be added or removed depending on the particular applications. One of ordinary skill in the art would recognize many variations, modifications, and alternatives.

In some embodiments, methods described herein may include an alternate configuration of steps as previously described. For example, the method of producing gas phase atoms or molecules may include the steps outlined in FIG. 2B.

FIG. 2B is a simplified flow chart illustrating a method of producing gas-phase atoms or molecules using systems and reagents according to an embodiment of the present invention. In some embodiments, the method includes providing a solid material (230). In some embodiments, the solid material may be an organic salt or a metal salt. In some embodiments, the metal salt may include radium or barium atoms. For example, the barium atoms may be a barium salt in the form of barium nitrate or barium chloride. In some embodiments, the radium may be a radium salt such as radium nitrate or radium chloride. In other embodiments, the solid material may be rare or isotopically pure materials. In alternative embodiments, rather than starting with a solid material, the method can utilize a solution including the atom of interest, for example, a solution including radium.

Due to the rarity of the solid material (or the material in solution), the method described herein is ideal for forming gas phase atoms or molecules from microgram (μg) quantities of material. In some embodiments, the solid material may be provided in an amount of from 0.1 μg to 20,000 μg. For example, the starting amount of the solid material may be from 0.1 μg to 10,000 μg, from 1 μg to 10,000 μg, from 10 μg to 10,000 μg, from 100 μg to 10,000 μg, from 1 μg to 20,000 μg, from 10 μg to 20,000 μg, from 100 μg to 20,000 μg, from 0.1 μg to 1,000 μg, from 0.1 μg to 100 μg, or from 0.1 μg to 10 μg.

In some embodiments, the method includes dissolving the solid material in a solution including at least one weak acid, a solvent, and at least one polyol to form a viscous mixture (232). In some embodiments, the weak acid may be at a final concentration of from about 0.05 M to 0.50 M. The weak acid may be added to help prevent the metal ions, such as radium, from adhering to a container while in solution. In some embodiments, the weak acid may be hydrochloric acid or nitric acid. In some embodiments, the solvent may be the weak acid, may be water, or may be an alternate solvent used to aid in dissolving the metal salt or organic salt. In some embodiments, the viscous mixture may include additional additives. The additional additives may be added to the mixture to improve the solubility of the metal or organic salt, may be added to stabilize the solution, or may be added to further increase the viscosity of the mixture. In embodiments that utilize a solution rather than a solid material, forming the viscous mixture can include mixing the solution including the atom of interest with an additional solvent or more of the solvent in the solution including the atom of interest, the weak acid, and the polyol.

The polyol may be used in the methods described herein due to their unique ability to not undergo a phase transition or caramelization during heating. For example, the polyol may be xylitol, lactitol, sorbitol, erythritol, arabitol, ribitol, or a combination thereof. Additionally, the use of the polyol as an additive enables the use of additional additives at lower concentrations. In particular, since the viscous mixture is formed as a volume rather than as a layer over a surface, the concentration of radium in the volume is reduced, thereby reducing the impact of radiolytic chemical reactions between the viscous mixture and the substrate produced by the radiation emitted from the radium.

For example, the xylitol utilized in solution facilitates the uniform distribution of dissolved solid material during the evaporation of water and may allow for a more consistent and repeatable target site by disrupting the formation of salt crystals. In some embodiments, the xylitol may be added to the solution in a final concentration of from 1 mM to 10 mM. For example, the concentration of polyol in solution may be 1 mM, 2 mM, 3 mM, 4 mM, 5 mM, 6 mM, 7 mM, 8 mM, 9 mM, or 10 mM. In some embodiments, the concentration of xylitol may be greater than 10 mM. For example, the concentration may be up to 1,000 mM.

In some embodiments, the viscous mixture, including at least one weak acid, at least one polyol, a solvent, and solid material, may have a viscosity of from 1 mPa/s to 10,000 mPa/s mPa/s. For example, the viscosity can be from 1 mPa/s to 10,000 mPa/s, from 1 mPa/s to 1000 mPa/s, from 1 mPa/s to 100 mPa/s, or from 1 mPa/s to 10 mPa/s. In some embodiments, the viscosity can be 1 mPa/s, 2 v, 3 mPa/s, 4 mPa/s, 5 mPa/s, 6 mPa/s, 7 mPa/s, 8 mPa/s, 9 mPa/s, 10 mPa/s, or greater than 10 mPa/s. In some embodiments, the viscosity can be 10 mPa/s, 20 mPa/s, 30 mPa/s, 40 mPa/s, 50 mPa/s, 60 mPa/s, 70 mPa/s, 80 mPa/s, 90 mPa/s, 10 mPa/s. In further embodiments, the viscosity can be from 1 mPa/s to 1500 mPa/s when in a liquid state. In some embodiments, in a dried state, the viscosity can be from 1000 mPa/s to 1×10⁶ mPa/s. In some embodiments, the viscosity solution can be 8.92 mPa/s

After production of the viscous mixture, the viscous mixture is drop-cast onto the substrate surface (234) forming a volumetrically distributed mixture on the substrate surface (236). In some embodiments, the substrate may be aluminum hydroxide, copper, silica aerogel (hydrophobic or hydrophilic), alumina of various porosity, non-porous alumina, quartz frit, Inconel, Hastelloy, silicon carbide, or gold electroplated onto copper, nickel, nickel on copper, or gold foil. In some embodiments, the substrate may be selected based on the environmental conditions. During the drop casting process, the solution prepared is pipet onto the surface of the target plate. In some embodiments, the step of drop casting may include adding about 0.5 μL to 5 μL of viscous solution to the substrate surface. For example, 0.5 μL, 1 μL 1.5 μL, 2.0 μL, 2.5 μL, 3.0 μL, 3.5 μL, 4.0 μL, 4.5 μL, or 5.0 μL may be added to the substrate surface. In examples using Radium, such as the ones described below, the drop-cast solution may include from 10 to 50 μCi of radium. The 50 μCi sample of radium-226 may contain roughly 221 nmol or about 10¹⁷ atoms of radium-226 that may produce a usable number of atoms for 10³ to 10⁴ ablation shots. In some embodiments, the pule energy of the laser may be reduced such that the number of usable atom produced per ablation shot may be 10¹, 10², 10³, 10⁴, 10⁵, 10⁶, 10⁷, 10⁸, 10⁹, 10¹⁰, 10¹¹, 10¹², 10¹³, 10¹⁴, or 10¹⁵ atoms per ablation shot.

Optionally, the method may include adding a co-target to the target plate as shown in FIG. 1C. The co-target may include ligand-containing species, hydroxide species, deuteroxide species, fluoride species, ytterbium (Yb) species, or other acids. For example, the compounds may be copper hydroxide, aluminum hydroxide, aluminum deuteroxide, aluminum hydroxide doped with Yb powder, telluric acid, boric acid, iron hydroxide, copper fluoride, or aluminum fluoride in combination with driving the metal atom to an electronic state with a resonant laser. The co-targets are produced into solid pellets formed by hydraulic pressing of the powder and adhering the pellet to the target plate positioned around the pure metal substrate. The co-target is ablated 10 ms before the volumetrically distributed target, filling the cell volume with a reagent cloud and desorbing helium to aid with thermalization and diffusion. In some embodiments, the co-target is ablated from 5 ms to 50 ms before ablation of the volumetrically distributed target.

Following drop casting, the target plate, including substrate, is heated to a temperature in a range of from 80° C. to 120° C. forming a volumetrically distributed target of material by evaporating (238) a liquid portion of the sample leaving behind a volumetrically distributed target on the substrate surface. In some embodiments, the substrate surface may include a thin material attached to the substrate. For example, a pure metal such as gold, platinum, iridium, tantalum, rhodium, titanium, or other metals that are unreactive or suitably resistant to radioisotopes and acids. As previously described above, the addition of the polyol increases the viscosity of the solution, such that upon drying, the droplets form a three dimensional (3-D) structure having a thickness along the Z-axis of the substrate surface. This uniform thickness aids in the distribution of target material per ablation spot. In some embodiments, the shape of the 3-D droplet may be an ovoid shape or a cylindrical shape, having a uniform thickness across the entire structure.

In some embodiments, the method may include positioning on the volumetrically distributed target on a substrate in a cell including an inert gas. In some embodiments, the inert gas may be nitrogen gas, helium gas, argon gas, xenon gas, neon gas, krypton gas, or any other inert gas. In some embodiments, the method may include positioning on the volumetrically distributed target on a substrate in a cell including a reactive gas. The cryogenic buffer gas cell is described with respect to FIG. 1B, above. The buffer gas cell is subsequently inserted into the cryocooler. In some embodiments, the cryocooler is subsequently cooled down to cryogenic temperatures.

Once the cryocooler is sealed, and the cell is brought to the proper pressure and temperature, the target spot may be ablated using a laser (240). In some embodiments, the laser may be a pulsed laser of a continuous wave laser. In some embodiments, the ablation parameters depend on the material and substrate. In one non-limiting example, the laser may be a Nd:YAG laser. In some embodiments, the method may include using more than one Nd:YAG laser. For example, the system may use 2 Nd:YAG lasers emitting light at 532 nm with a pulse duration of about 10 nanoseconds (ns) and having a beam diameter of about 1 centimeter (cm). In some embodiments, the beam diameter may be from 5 mm to about 10 mm. for example, the beam diameter may be 5 mm, 5 mm, 7 mm, 8 mm, 9 mm, or 10 mm.

The laser is positioned external to the cryocooler having a focal lens positioned between the cryocooler and the laser to focus the beams onto the target plate. In some embodiments, the focal length lens may have a focal length of from 100 mm to 400 mm. For example, the focal length may be 100 mm, 200 mm, 300 mm, or 400 mm. Furthermore, the laser ablation energy may be from 5 mJ/pulse to 50 mJ/pulse. For example, the laser ablation energy may be 5 mJ/pulse, 10 mJ/pulse, 15 mJ/pulse, 20 mJ/pulse, 25 mJ/pulse, 30 mJ/pulse, 35 mJ/pulse, 40 mJ/pulse, 45 mJ/pulse, or 50 mJ/pulse.

In some embodiments, the substrate may be ablated from 10 to 100 times in a single spot before the target sample is depleted. For example, the same spot may be ablated 10 times, 20 times, 30 times, 40 times, 50 times, 60 times, 70 times, 80 times, 90 times, 100 times, 200 times, 300 times, 400 times, 500 times, 600 times, 700 times, 800 times, 900 times, 1000 times, 2000 times, 3000 times, 4000 times, 5000 times, 6000 times, 7000 times, 8000 times, or 9000 times, or 10000 times before the sample is completely depleted and the laser spot need be repositioned. In some embodiments, the method may include reducing the pulse energy of the laser to reduce the number of atoms produced per shot.

The laser ablation of the sample may result in production of gas phase atoms or molecules (242). In some embodiments, the gas phase atoms or molecules include natural atoms. In some embodiments, the gas phase atoms include atomic radium. The methods described herein may be used for producing neutral atoms from starting materials. This is in contrast to methods such as mass spectrometry. For example, in mass spectrometry, an ionization step is required to generate charged particles from proteins, materials, or other samples that are then filtered or manipulated based on their mass-to-charge ratio using electric or magnetic fields to gain chemical and structural information. However, neutral atoms or molecules do not respond to the fields used in mass spectrometers and thus cannot be measured directly. The methods described herein form neutral particles rather than ionic species. For example, the methods described above produce neutral atoms or molecules, such as atomic radium, that are neither formed nor desired in mass spectrometry. The neutral atoms and molecules may be suitable for other downstream applications including, but not limited to, spectroscopy and fundamental physics research applications. These methods could be used with little modification as sources for any application needing gas-phase atoms and molecules, including materials science applications, device fabrication, chemical analysis and synthesis, field sensing, and quantum information processing platforms. This method could also be used for chemical and spectroscopic analysis of samples, especially for the analysis of trace impurities; since the apparatus works at cryogenic temperatures and offers high spectroscopic resolution, this could be used for isotopic analysis as well. The methods described herein, while generally being employed for producing neutral particles, may be employed for generating ionic species.

It should be appreciated that the specific steps illustrated in FIG. 2B provide a particular method of producing gas-phase atoms or molecules using systems and reagents according to an embodiment of the present invention. Other sequences of steps may also be performed according to alternative embodiments. For example, alternative embodiments of the present invention may perform the steps outlined above in a different order. Moreover, the individual steps illustrated in FIG. 2B may include multiple sub-steps that may be performed in various sequences as appropriate to the individual step. Furthermore, additional steps may be added or removed depending on the particular applications. One of ordinary skill in the art would recognize many variations, modifications, and alternatives.

In some embodiments, the method of forming a gas phase atom or molecule may be dependent upon the substrate surface selected. For example, an alternate method described herein is briefly described in FIG. 2C.

FIG. 2C is a simplified flow chart illustrating a method of producing gas-phase atoms or molecules using systems and reagents according to an embodiment of the present invention. In some embodiments, the method includes an initial step of providing a solid material (250). The solid material may be the same solid material as previously described in FIG. 2B. For example, the solid material may be an organic salt or a metal salt. The metal salt may be a radium salt, such as radium chloride or radium nitrate, or a barium salt, such as barium nitrate or barium chloride. It may be understood by one skilled in the art that the methods described herein are not limited to only barium and radium. The methods described herein may be employed on other metals such as other radioactive isotopes or other exotic nuclei that typically suffer from small sample volumes, such as less than 20,000 pgs. In some embodiments, the solid material may be provided in an amount of from 0.1 μg to 20,000 μg. For example, the starting amount of the solid material may be from 0.1 μg to 10,000 μg, from 1 μg to 10,000 μg, from 10 μg to 10,000 μg, from 100 μg to 10,000 μg, from 1 μg to 20,000 μg, from 10 μg to 20,000 μg, from 100 μg to 20,000 μg, from 0.1 μg to 1,000 μg, from 0.1 μg to 100 μg, or from 0.1 μg to 10 μg.

The solid material may be dissolved in a solvent, and at least one acid to form a viscous mixture (252). In some embodiments, the viscous mixture may include other additives such as stabilizing agents, viscosifiers, a buffer, an internal standard, matrix modifier, or a chelating agent. In some embodiments, the viscous mixture includes the solid material and a weak acid. In some embodiments, the weak acid may be at a final concentration of from about 0.05 M to 0.50 M. The weak acid may be added to help prevent the metal ions, such as radium, from adhering to a container while in solution. In some embodiments, the weak acid may be hydrochloric acid or nitric acid. In some embodiments, the solvent may be the weak acid, may be water, including deionized water, or may be an alternate solvent used to aid in dissolving the metal salt or organic salt. In embodiments that utilize a solution rather than a solid material, forming the viscous mixture can include mixing the solution including the atom of interest with an additional solvent or more of the solvent in the solution including the atom of interest and the weak acid. In some embodiments, a polyol may be added to the viscous mixture. The polyol may include xylitol, lactitol, sorbitol, erythritol, arabitol, ribitol, or a combination thereof. In embodiments including the polyol, the final concentration of polyol is described with respect to FIG. 2B.

In some embodiments, the viscous mixture is drop-cast onto the porous alumina surface (254). In some embodiments, the alumina substrate may be non-porous or porous. The alumina may be 10% porous, 20% porous, 30% porous, 40% porous, or 50% porous. In some embodiments, the porous alumina may be in a bisque state.

The viscous mixture is allowed to settle on the porous alumina substrate to distribute the viscous mixture throughout the porous alumina (256). Following distribution of the viscous mixture through the porous alumina, the porous alumina may be heated to evaporate the solvent from the viscous mixture to form a target volume inside the porous alumina (258). In some embodiments, the porous alumina is heated to a temperature in a range of from 80° C. to 120° C. For example, the porous alumina is heated to 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., or 120° C. In yet other embodiments, the porous alumina is maintained at a temperature below 80° C. For example, the temperature of the porous alumina may be 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., or 80° C.

In some embodiments, the porous alumina substrate on the target plate is positioned in a cell. The cell may be evacuated to a pressure in a range of 1×10⁻⁴ torr to 1×10⁻¹³ torr.

In some embodiments, the methods described herein may include ablating the target volume with a laser (260). The operational parameters described above, such as in FIG. 2B, may be applied to the method described herein to generate the gas phase atoms or molecules. The laser ablation forms gas phase atoms or particles (262) that may be used in further downstream applications.

It should be appreciated that the specific steps illustrated in FIG. 2C provide a particular method of producing gas-phase atoms or molecules using systems and reagents according to an embodiment of the present invention. Other sequences of steps may also be performed according to alternative embodiments. For example, alternative embodiments of the present invention may perform the steps outlined above in a different order. Moreover, the individual steps illustrated in FIG. 2C may include multiple sub-steps that may be performed in various sequences as appropriate to the individual step. Furthermore, additional steps may be added or removed depending on the particular applications. One of ordinary skill in the art would recognize many variations, modifications, and alternatives.

The following examples are offered to illustrate, but not to limit, the present disclosure.

### Example 1. Analysis of Concentration and Substrate Selection on Dispersion Kinetics

To assess the impact of substrate surface and the impact of additives on the chemical composition and volumetrically distributed target (e.g., a thin film) forming capabilities, a series of samples were prepared using radium and barium compounds as the target material. The target materials were dissolved in 100 μL of 0.1 M acid (HCl for radium chloride, HNO₃ for radium nitrate).

An additive was optionally added to the target material in acid. The additives included xylitol, boric acid, aluminum hydroxide, PVA, sucrose, or Rhodamine 6G dye tracer. The samples were drop-cast onto the various substrate surface and the substrate as subsequently heated to a temperature in the range of 80° C. to 120° C. The buffer gas cells were subsequently loaded into a 5 K cryogenic helium buffer gas cell using target preparation methods described above. The resulting film was ablated in a particular spot until no more material was removed, the integrated gas phase atomic yield from the individual spot was reported, and the laser was subsequently positioned to another spot to repeat the steps. Atomic densities were measured via resonant absorption spectroscopy on the gas phase atoms. The observations from the resulting combinations are briefly described in Table 1, below.

TABLE 1
Additive and Substrate Combinations for Metal Chlorides and Metal Nitrates.

| Metal Source | Substrate | Additive | Notes |
|---|---|---|---|
| BaCl₂ (4.5 mmol) in | Aluminum | None | Inconsistent atom |
| HCl | Hydroxide | | production, poor |
| | | | molecule production |
| RaCl₂ (30 and 45 | Copper, gold, | None | Good but inconsistent |
| nmol = 6.66 5 10 μg), | electroplated gold on | | atom production at |
| BaCl₂ (45, 90, 4500, | copper & on gold | | 5K due to coffee ring |
| 9000 nmol) in HCl | | | and radiolysis. |
| Ba(NO₂)₃ (45 nmol) | Copper | Boric acid, aluminum | Poor adhesion to |
| in nitric acid | | hydroxide, PVA | surface at room |
| | | | temperature |
| Nitric acid only | Copper | Sucrose, table sugar | Poor adhesion to |
| | | | surface at room |
| | | | temperature, |
| | | | inconsistent |
| | | | properties upon |
| | | | heating and attempted |
| | | | caramelization. |
| Ba(NO₂)₃ (45 nmol) | Gold | Sucrose, table sugar | Good adhesion at |
| in nitric acid | | | room temperature, |
| | | | required heating to |
| | | | caramelization point |
| | | | which left |
| | | | inconsistent bubbles |
| | | | in the deposition |
| Ba(NO₂)₃ (450 | Copper, gold | Xylitol | Good adhesion, |
| nmol), Ra(NO₂)₃ (90, | | | consistent ablation |
| 112.5, 225 nmol) in | | | atom production at 5K |
| nitric acid | | | |
| None | Silica aerogel | Rhodamine 6G dye | Hydrophilic aerogel |
| | (hydrophilic and | tracer | broke apart |
| | hydrophobic) | | immediately. |
| | | | Hydrophobic was |
| | | | visually promising, |
| | | | but evaporation took |
| | | | a very long time and |
| | | | thus not tested at |
| | | | cryogenic |
| | | | temperatures. |
| BaCl₂ (45 nmol), | Alumina of various | None, Rhodamine 6G | Appeared promising |
| none | porosity (non-porous, | dye tracer | but not tested at 5K. |
| | 48%, 36% bisque) | | Depth of material |
| | | | deposition could be |
| | | | controlled with |
| | | | different porosity. |
| Ra(NO₂)₃ (6.66 μCi = | Alumina of various | None | Very consistent atom |
| 6.66 μg = 30 nmol), | porosity (non-porous, | | production at 5K |
| Ba(NO₂)₃ in nitric | 48%, 36% bisque) | | |
| acid | | | |
| Ba(NO₂)₃ (45 nmol), | Copper, Gold | None | Good but inconsistent |
| Ra(NO₂)₃ (30, 45 | | | atom production at |
| nmol) in nitric acid | | | 5K due to coffee ring |
| | | | and radiolysis. |
| BaCl₂ (45 nmol) in | Quartz frit | None | Liquid passed |
| HCl | | | through too quickly |
| | | | to deposit, but could |
| | | | use lower porosity. |
| BaCl₂ (4500 nmol) in | Inconel, Hastelloy, | None | All deposited the |
| HCl | silicon carbide | | material in a larger |
| | | | area and with a worse |
| | | | coffee ring than plain |
| | | | copper. |

As observed in Table 1, the barium and radium samples that included the additive xylitol had good adhesion and produced consistent ablation atoms at 5 K. However, samples that included sucrose resulted in caramelization resulting in inconsistent bubbling of the film during evaporation.

Additionally, it was observed that using alumina with varying porosity also achieved good substrate surface adhesion and a consistent atom production at 5K. Thus, the results demonstrate that depending on the substrate surface, the additive may not be required to form the gas phase atoms.

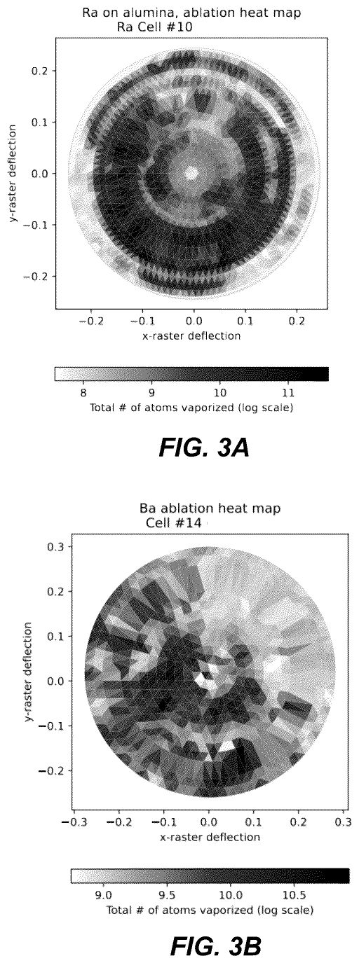

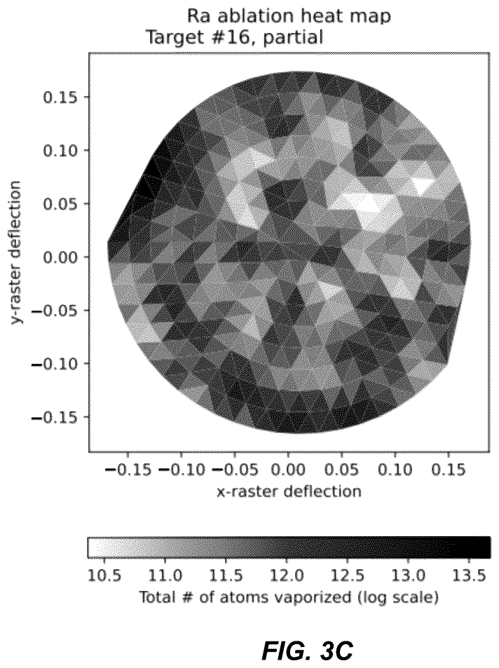

FIG. 3A is a plot illustrating the spatial distribution of ablation spots and the integrated number of atoms vaporized for Radium on an alumina substrate according to an embodiment of the present invention. The plot shows the spatial distribution of ablation spots and the integrated number of atoms vaporized for atomic radium. The atomic radium was produced by ablating drop-casted radium nitrate in 0.1 M nitric acid onto non-porous alumina. The ablation energy used was 5-20 mJ/pulse. As illustrated in FIG. 3A, the total number of atoms vaporized was consistent throughout the majority of the sample distributed on the surface.

A similar observation was seen in FIG. 3B. FIG. 3B is a plot illustrating the spatial distribution of ablation spots and the integrated number of atoms vaporized for Barium on an alumina substrate according to an embodiment of the present invention. The plot shows the spatial distribution of ablation spots and the integrated number of atoms vaporized for atomic radium. The atomic barium was produced by ablating drop-casted barium nitrate in 0.1 M nitric acid and mixed with xylitol onto a gold substrate surface. The ablation energy used was 5-20 mJ/pulse. As illustrated in FIG. 3B, the total number of atoms vaporized was consistent throughout the majority of the sample distributed on the surface.

FIG. 3C is a plot illustrating the spatial distribution of ablation spots and the integrated number of atoms vaporized for Barium on an alumina substrate according to an embodiment of the present invention. The plot shows the spatial distribution of ablation spots and the integrated number of atoms vaporized for atomic radium. The atomic radium was produced by ablating drop-casted radium nitrate in 0.1 M nitric acid and mixed with xylitol onto a gold substrate surface. The ablation energy used was 5-20 mJ/pulse. As illustrated in FIG. 3B, the total number of atoms vaporized was consistent throughout the majority of the sample distributed on the surface.

To assess the impact of sucrose concentration and xylitol concentration on volumetrically distributed target characteristics, sample solutions were prepared by dissolving various concentrations of the sugar or sugar alcohol in 0.1 M acid solution. The samples were drop-cast onto the surface and subsequently heated to a temperature of about 85° C. Without heating, the samples may take up to 24 hours to dry, adding an undesirable amount of time to the sample preparation.

FIG. 4A is a photograph depicting the surface structure for the target compounds following evaporation and heating according to an embodiment of the present invention. Similarly, FIG. 4B is a photograph depicting and alternate view of FIG. 4A showing the relative height of caramelization observed for the target compounds following evaporation and heating according to an embodiment of the present invention. As demonstrated in FIGS. 4A and 4B, the samples containing from 0.1 to 4000 mM of sucrose resulted in either a coffee ring effect of sample distribution, or a noticeable formation of bubbles resulting in an inadequate distribution of sample material. However, with the inclusion of xylitol, a flat uniform sample distribution was observed. The observations seen at various concentrations are shown in Table 2, below.

TABLE 2
Concentration dependent Surface formation of Thin Film.

| Concentration | | | |
|---|---|---|---|
| range (nM) | | Sucrose | Xylitol |
| 0.1-1 | mM | Noticeable coffee | Noticeable coffee ring, some material present on |
| | | ring. Not tested in the | the inside. When tested in the experiment, results |
| | | apparatus. | in a nonuniform distribution of material. (Spot 5) |
| 1-10 | mM | Formed a short, | Flat, uniform-looking and clear-colored. (spot 2) |
| | | bubbly crystal | |
| 10-100 | mM | Formed a tall, bubbly | Flat, uniform-looking and color ranging from |
| | | crystal (spot 1) | clear-yellow to dark brown. This concentration |
| | | | was used in the past but the difficulty in producing |
| | | | consistent targets from run to run. |
| 100-1000 | mM | Formed a tall, bubbly | Flat and uniformly dark. However, requires a very |
| | | crystal. Evaporation | long evaporation time due to high surface tension |
| | | took upwards of 10 | preventing water escape. |
| | | minutes per drop. | |
| | | (spot 3) | |
| 1000-4000 | mM | Formed a tall, | Tall and bubbly droplet. |
| | | caramel-colored | |
| | | droplet that never | |
| | | appeared to fully | |
| | | evaporate. (spot 4) | |

Taken collectively, the results demonstrate the ability to form gaseous samples (e.g., cryogenic gaseous samples) of atoms and molecules for spectroscopy and fundamental physics research. The methods could be used with little modifications for any applications needing gas-phase atoms and molecules, including materials science applications, device fabrication, chemical analysis and synthesis, field sensing, and quantum information processing platforms. The method may also be employed for chemical and spectroscopic analysis of samples, especially for the analysis of trace impurities. The methods described herein demonstrate the ability to perform such methods work at cryogenic temperatures and offer high spectroscopic resolution. For example, the results herein demonstrate the successful formation of consistent gaseous atoms or molecules when a polyol, such as xylitol, is added to the solution. Additionally, when the substrate surface is an alumina, the method may not include adding a polyol to increase the viscosity. This may be beneficial for situations requiring highly reactive chemicals or where high purity is of concern. The methods described herein may also offer a route for depositing a larger amount of material.

### Example 2. Sample Preparation and Data Acquisition

### Radium Target

Radium-226 ablation targets were made by evaporation of an aqueous radium salt solution onto an inert substrate, a process referred to as “drop casting.” Both radium chloride (RaCl₂) and radium nitrate (Ra(NO₃)₂) were employed for initial testing. RaOH was utilized for survey spectroscopy. 10 μCi radium chloride solutions were supplied by Eckert & Ziegler. Subsequent targets were made from radium nitrate, which was acquired as 1 mCi of dried salt from the U.S. Department of Energy National Isotope Development Center and Oak Ridge National Laboratory. Upon receipt, the dried salt was dissolved and aliquoted into smaller activities for target preparation and medium-term storage.

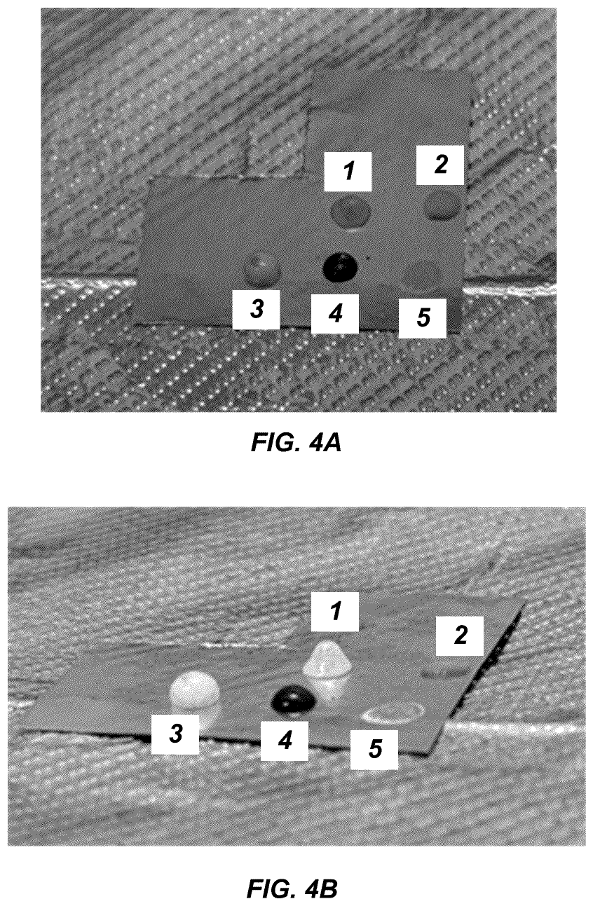

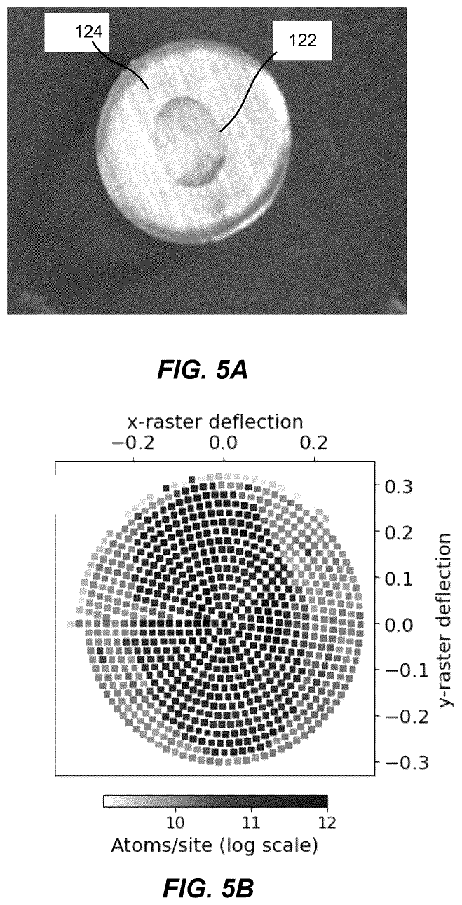

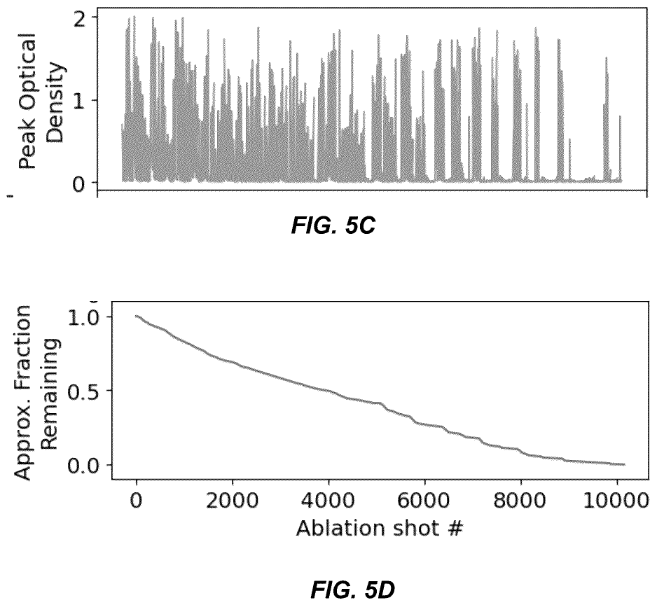

Drop casted solutions contained 10-50 μCi of Ra-226 in 100 μL of 0.1 M acid (HCl for radium chloride, HNO₃ for radium nitrate). Prior to drop casting, a small amount (~0.1 mg, 1-10 mM final concentration) of xylitol was added to the solution to facilitate a uniform deposition of radium during evaporation. The consistency and atomic distribution for a typical radium target with xylitol is depicted in FIGS. 5A-5D.

FIG. 5A is an image illustrating deposition of a translucent gel on the center of a pure metal substrate positioned on a target plate according to an embodiment of the present invention. Dissolving the xylitol into the solution yields a viscous syrup that evaporates into a translucent gel depicted in FIG. 5A. For example, the pure metal substrate 124 is shown with the target material 122 formed on the substrate surface. The target material 122 can thus include radium supported in a matrix and formed on the surface of pure metal substrate 124 as a transparent gel. As discussed herein, the target material 122 can be prepared by mixing a radium nitrate solution with a weak acid (e.g., nitric acid) and adding a polyol (e.g., xylitol). The mixture can be pipetted onto a heated substrate, i.e., pure metal substrate 124, which induces evaporation of the water contained in the mixture. After evaporation, the gel illustrated in FIG. 5A is formed.

FIG. 5B is a simplified plot of a raster scan of the ablated target surface showing a concentration of atoms found in the translucent gel according to an embodiment of the present invention. Atomic ablation yields off of the target can be inferred by absorption on the ¹S₀-¹P₁ Ra transition, which indicates good shot-to-shot consistency over the spatial extent of the target, as shown in FIG. 5B.

It should be noted that in contrast with conventional laser ablation sources, the target material provided by embodiments of the present invention is characterized by a high level of atomic spatial uniformity across the target material (e.g., uniformity of radium distribution within the volume of the target material). Without limiting embodiments of the present invention, the inventors believe that spatial uniformity observed in conventional approaches is adversely impacted by uneven drying dynamics, chemical reactions at the substrate surface, or the like. This non-uniformity can be increased by the presence of radium in the radium nitrate/nitric acid mixture due to the radioactivity of radium, which can result in chemical reactions driven by the radioactivity of radium. In contrast, embodiments of the present invention provide radium uniformly embedded in the matrix across the volume of the matrix. The uniform distribution of radium throughout the volume of the target material enables the target material to be more robust in the presence of surface imperfections in the substrate surface, and is maintained during cooling to cryogenic temperatures. Moreover, the target material is mechanically stable (i.e., preventing peeling and flaking of the target material) and can survive temperature cycling from cryogenic temperature back to room temperature as well as the intense radiation produced by the radium.

As discussed above, an additive, e.g., a polyol such as xylitol, can be added to the mixture to increase the viscosity of the mixture. Without limiting embodiments of the present invention, the inventors believe that the increased viscosity provided by the addition of the additive (e.g., xylitol) reduces the convective flows that would otherwise be present in the mixture during evaporation of the water or other solvent, resulting in settling of the atoms (e.g., radium) to the substrate surface in an uneven pattern during the drying process. In contrast, the high viscosity of the mixture reduces or prevents the operation of these processes that would otherwise produce a non-uniform target material after drying. Additionally, non-uniformity can also arise from chemical reactions with the substrate driven by the radiation emitted from the radium. The use of a substantially inert surface in the form of a gold substrate, reduces these chemical reactions that would otherwise occur.

Referring once again to FIG. 5B, which illustrates the concentration of atoms found in the translucent gel as a function of x-y position, radium atoms created by laser ablation are plotted as a function of position. The uniformity of the radium distribution, discussed above, is apparent in FIG. 5B. Moreover, summation of the atoms produced during laser ablation correlates with the number of atoms initially added to the mixture, confirming that radium atoms were produced with high efficiency. The methods described herein form neutral particles rather than ionic species. For example, the methods described above produce neutral atoms or molecules, such as atomic radium, that are neither formed nor desired in mass spectrometry. The neutral atoms and molecules may be suitable for other downstream applications including, but not limited to, spectroscopy and fundamental physics research applications. These methods could be used with little modification as sources for any application needing gas-phase atoms and molecules, including materials science applications, device fabrication, chemical analysis and synthesis, field sensing, and quantum information processing platforms. This method could also be used for chemical and spectroscopic analysis of samples, especially for the analysis of trace impurities; since the apparatus works at cryogenic temperatures and offers high spectroscopic resolution, this could be used for isotopic analysis as well.

FIG. 5C is a plot depicting the optical density per shot (OD=−ln(T) for transmission T) with respect to ablation shot number according to an embodiment of the present invention. FIG. 5D is a plot of the estimated mass fraction of the target that has been used based on rate of depletion per shot according to an embodiment of the present invention. Approximately 10⁴ shots are taken over about 10³ unique ablation raster sites per target. Atomic absorption data here is taken in the presence of strong optical pumping from the ¹S₀-³P₁ light, which partially depletes the ¹S₀ ground state population, thus reducing the total atoms detected. Atom numbers in FIG. 5D should be interpreted for relative shot-to-shot comparison, but are not indicative of total yields.

From the radium solution, 2 μL-sized drops were pipetted onto a heated target plate and allowed to fully evaporate until the entire sample has been deposited. The target plate was a copper C10100 substrate with a 0.1-mm-thick, 5/16-inch-diameter piece of pure gold foil epoxied on the center using Stycast 2850FT Black with catalyst 24LV. The radium solution was drop-casted onto the gold foil. Initial attempts to drop-cast the solution onto bare or gold-electroplated copper resulted in unexpected and unreliable chemical reactions, which led to inconsistent targets. While not being bound by any theory, it is hypothesized that the reactivity observed may be attributed to radiolysis since these effects were not present in barium salt solutions used for testing, even at higher acid concentrations and temperatures.

With 50 μCi of radium-226 (221 nmol≈10¹⁷ atoms), a single target may produce a usable number of atoms for 103-104 ablation shots (see FIGS. 5A-5D) at a specified pulse energy. In some embodiments, the pulse energy may be reduced to increase the number of ablation shots producing a usable number of atoms. For example, the number of usable atom produced per ablation shot may be 10¹, 10², 10³, 10⁴, 10⁵, 10⁶, 10⁷, 10⁸, 10⁹, 10¹⁰, 10¹¹, 10¹², 10¹³, 10¹⁴, or 10¹⁵ atoms per ablation shot. Target production parameters described above are chosen to maximize the number of shots that produce large molecule signals, and can be adjusted to get an even larger number of atomic ablation shots at the cost of smaller molecule fluorescence. Because the evaporated material forms a thin layer, all of the desired atoms at a particular ablation laser focus spot will be depleted after around 10 to 100 shots. Motorized mirror mounts were used to automatically raster the ablation laser over the bounds of the target as shown in FIG. 5B. Once the target was completely depleted, the contaminated cell was disposed of and a new one is prepared for installation. Other metal salts were explored as described in Example 1 and consistently created atoms and molecules. Thus, it is anticipated that the protocol described herein could be used for larger quantities and activities.

### Co-Target Production

The reagent target, or “co-target,” was composed of a powder mixture comprising a reagent (e.g., Al(OH)₃, CuF₂, or Al(OD)₃) and 5% by mass of polyethylene glycol (PEG) to act as a binder. These powders are generally commercially available, except for Al(OD)₃, which was synthesized in-house as described below. The powder mixture was hydraulically pressed in an 8-mm-diameter die under a pressure of 1 GPa for approximately 30 minutes, forming a pellet with a typical mass of ~0.2 g. The approximate densities of the respective pressed powder targets were 2.9 g/cm³ for CuF₂, 2.0 g/cm³ for Al(OH)₃, and 1.9 g/cm³ for Al(OD)₃. After pressing, the circular pellets were cut to the desired size with a razor blade and epoxied to the copper target plate containing the deposited radium using Stycast 2850FT Black with catalyst 24LV.

The deuterated analogue of the hydroxide co-target, aluminum deuteroxide (Al(OD)₃), is not commercially available. Aluminum deuteroxide was synthesized via the decomposition of aluminum nitride in heavy water, AlN+3D₂O→Al(OD)₃+ND₃. Following the corresponding procedure for aluminum hydroxide, 3.675 g of AlN was added to 100 ml of D₂O and stirred at 40° C. for 48 hours. After the solution cooled, the majority of the ND₃ supernatant was decanted and the precipitate was dried in a vacuum oven for 24 hours at 50° C. The final mass was 6.13 g; assuming a full conversion of AlN→Al(OD)₃, this corresponds to a chemical yield of 85%.

### Ablation Production and Cooling

Molecules were produced in a cryogenic buffer gas. Helium is initially loaded into a known room-temperature calibration volume until a desired pressure is reached, after which it is added to the cell to achieve an approximate density of (10¹⁵-10¹⁶) atoms/cm³. During operation, the instantaneous helium pressure inside the cell can deviate from simple ideal gas law scaling due to the effects of helium desorption from the pressed powder reagent targets. The operational buffer gas quantity is determined empirically by optimizing on a molecular fluorescence signal for a known species, such as YbOH. While the cryosystem can achieve a base temperature of 4.2 K, heaters are used to hold the cell at 7 K during routine operation. At 7 K, a more intense and longer-lived molecule fluorescence signal is observed, which may be attributed to the desorption of helium off of the co-targets following ablation.

The ablation beams originate from separate pulsed Nd:YAG lasers, which emit at 532 nm with a pulse duration of ≈10 ns and beam diameter of ≈1 cm. A 200 mm focal length lens external to the cryostat focuses the beams onto the target plate. Pulse energies of the two lasers were optimized for molecule production and may vary depending on the target, but are generally 5 mJ for the radium drop-cast target and 20 mJ for the pressed powder reagent. The co-target was ablated 10 ms before the radium, filling the cell volume with a reagent cloud and desorbing helium to aid with thermalization and diffusion. Many delay timings were assessed, and similar molecule production efficiency was observed when delaying the Ra ablation anywhere from 5 to 50 ms after the co-target.

As the targets are ablated away, the lasers were moved to hit new regions. For the powder reagent movement of the laser happened after a few hundred ablation shots, and was done by periodically steering a mirror mount by hand. Spots on the drop-cast radium target were refreshed much more frequently, from every ten to hundred ablation shots. In order to maximize usage of the drop-cast radium material, motorized mirror mounts were used to raster the ablation beam over the spatial extent of the drop-cast target shown in FIG. 5A. Because of the trace quantities involved, the experimental duty cycle was limited to roughly 1 Hz to enable human intervention and real-time adjustment of experimental parameters, although much higher data taking rates are possible.

### Chemical Production and Enhancement

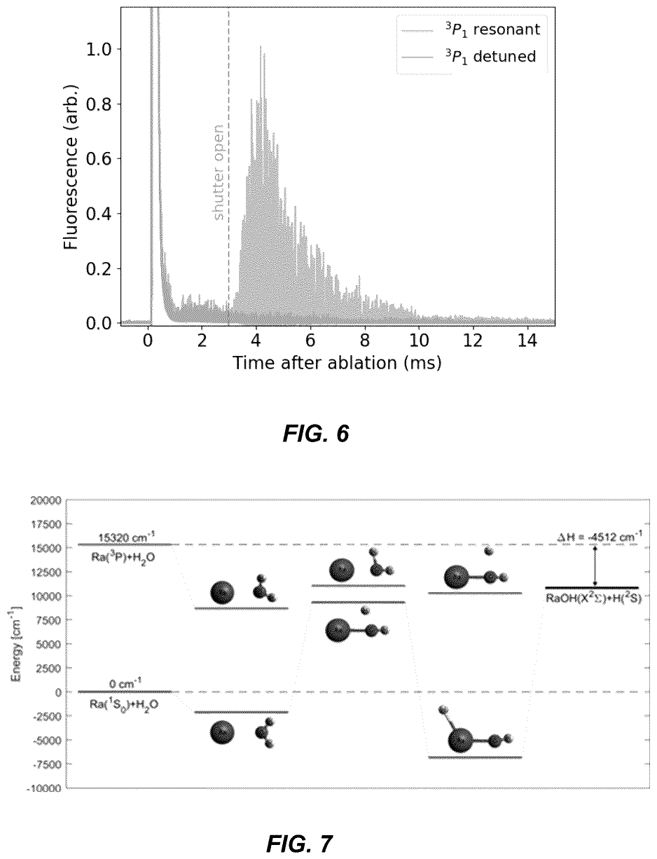

Molecular yields were enhanced via laser excitation of radium to the metastable ³P₁ state at 714 nm. Experiments that produce alkaline earth monofluorides generally use fluoride-containing gases, such as SF₆, CF₄, or NF₃, as the reagent. Chemical enhancement was shown to often reduce the total molecule signal, as the ground-state reaction is exothermic and further excitation favors the formation of difluorides. However, the powder target reagent does in fact benefit molecule production to a similar extent for hydroxides, shown in FIG. 6. Chemical enhancement was also observed for BaF in the same apparatus, and it may be expected that this approach could be used for other alkaline earth fluorides as well.

FIG. 6 is a plot of the fluorescence of radium-226 monofluoride (RaF) taken on the RaF

$${X}^{2} {Σ}_{1 / 2}^{+} ( {v}^{″} = 1 ) - {C}^{2} {Σ}_{1 / 2}^{+} ( {v}^{″} = 0 )$$

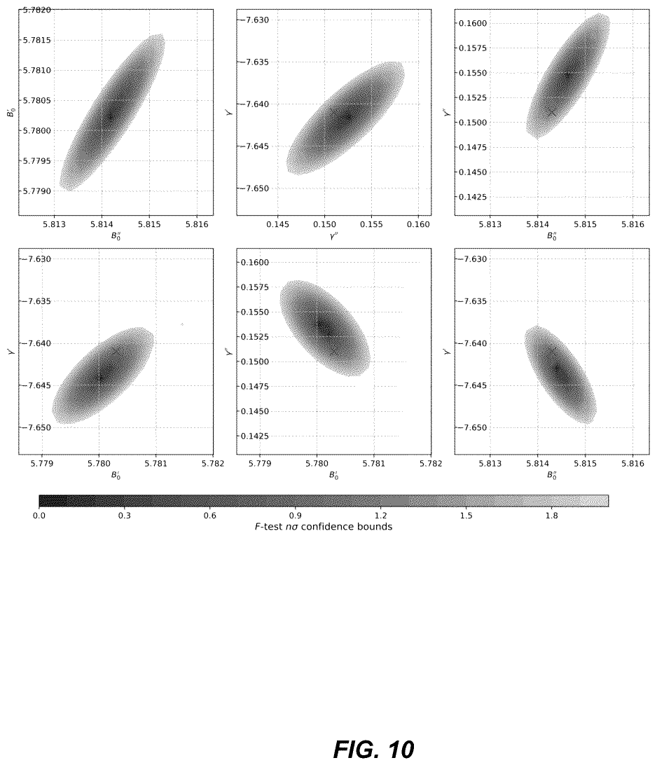

transition using pulsed dye excitation while ablating a pressed powder CuF₂ co-target according to an embodiment of the present invention. Measurements were taken similarly to FIG. 10D on the RaF

$${X}^{2} {Σ}_{1 / 2}^{+} ( {v}^{″} = 1 ) - {C}^{2} {Σ}_{1 / 2}^{+} ( {v}^{″} = 0 )$$

transition using pulsed dye excitation while ablating the pressed powder CuF₂ co-target. A laser shutter blocking the enhancement light was opened 3 ms after ablation and results in a 20-fold increase in molecule production when resonant with the ¹S₀→³P₁ transition in ²²⁶Ra. A similar effect was not observed in experiments producing alkaline earth(-like) monofluorides using SF₆ and NF₃ reagents.

In order to understand the energetics of the chemical reaction between excited Ra atoms and molecules produced by ablation, electron density-based quantum chemical calculations of the reaction profile were performed, similar to those conducted for YbOH. As an example reaction, the formation of RaOH via Ra insertion into H2O was considered, which is a prototypical although not exclusive byproduct of ablation. To obtain the equilibrium energies of reaction minima and transition states on the singlet Ra(1S)+H2O and triplet Ra(3P)+H2O potential energy surfaces, critical point searches were performed on the reaction geometry using numerical Hessian and eigenvector-following methods. These computations were performed in Q-Chem 5.3 using the spin-unrestricted UCAM-B3LYP density functional and the diffuse, correlation-consistent aug-cc-pVTZ basis set for 0 and H atoms, and the correlation-consistent cc-pVQZ-PP basis set with the Stuttgart ECP78MDF effective core potential for the Ra atom. The calculation approach was validated by reproducing the reaction Yb+H2O using the UCAM-B3LYP functional, the aug-cc-pVTZ basis set for 0 and H atoms, and the segmented def2-TZVP basis set with the ECP28MWB pseudopotential for the Yb atom.

The results for the RaOH formation pathways are summarized in FIG. 7. The molecular models, generated using Avogadro 1.9, represent the geometries at those critical points. The energies are from calculations described in the text. The reaction between ground state Ra and H₂O is endothermic, requiring energy to yield products, while the excited Ra reaction is exothermic and has a submerged transition state barrier. Thus, the Ra(³P)+H₂O reaction should have a large reaction rate and is preferable for the synthesis of RaOH.

### Spectral Data Collection

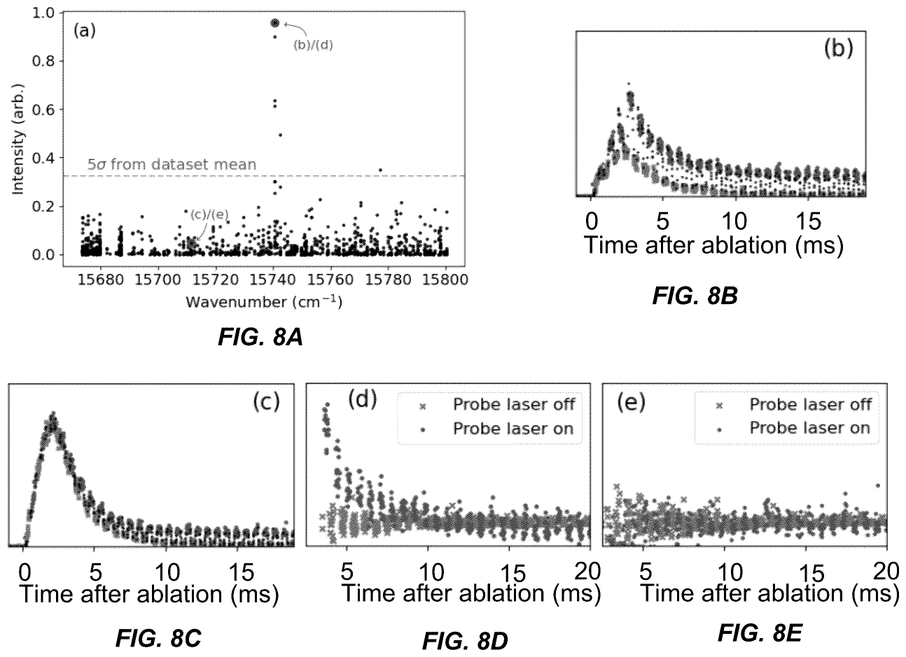

RaOH spectra were collected at iterative levels of resolution, from coarse Δν~30 GHz survey resolution, followed by Δν~2.5 GHz resolution, and ultimately Δν~100 MHz Doppler-limited resolution. The ~30 GHz scan data are shown in FIGS. 8A-8E. The high resolution lines and fits are shown in Table 3. FIGS. 8A-8E illustrate low-resolution survey scan data showing the initial identification of RaOH. More than 100 cm⁻¹ was scanned with linewidth Δν~1 cm⁻¹ around the predicted transition energy of 15749 cm⁻¹. The entire scan is shown in FIG. 8A, highlighting the region of high fluorescence intensity near 15740 cm⁻¹. Raw data for highlighted points at 15740.5 and 15711.3 cm⁻¹ are shown in FIG. 8B and FIG. 8C, respectively, showing the early-time fluorescence due to nonresonant glow. The modulation frequency was only 1.5 kHz as the data was taken using a mechanical chopper wheel instead of an acousto-optic modulator used in other data collection. FIGS. 8D-8E show the background-subtracted signal of FIGS. 8B-8C, emphasizing the excess fluorescence present at early time when the laser is resonant and passing through the cell in FIG. 8B.

TABLE 3
Observed and predicted transition wavenumbers for the \tilde{C}²Σ⁺(0, 0, 0) −
\tilde{χ}²Σ⁺(0, 0, 0) band of RaOH and RaOD in wavenumbers (cm⁻¹).

| | | | | | | | |
|---|---|---|---|---|---|---|---|
| Assign.^{a} | Obs.^{b} | Δν^{c} | Δν^{d} | Assign.^{a} | Obs.^{b} | Δν^{c} | Δν^{d} |

RaOH

| | | | | | | | |
|---|---|---|---|---|---|---|---|
| ^{P}P₁₁(N″) | | | | ^{P}P₂₂(N″) | | | |
| (1) | 39.03143(4) | −0.0002 | −0.0011 | (2) | 38.9078(2) | 0.0014 | 0.0008 |
| (2) | 38.51250(8) | 0.0010 | 0.0001 | (3) | 38.64436(3) | 0.0004 | 0.0000 |
| (3) | 37.9902(2) | 0.0011 | 0.0003 | (4) | 38.37921(1) | 0.0000 | 0.0001 |
| (4) | 37.4653(1) | 0.0008 | 0.0005 | (5) | 38.1116(1) | −0.0006 | −0.0002 |
| ^{P}Q₁₂(N″) | | | | ^{R}Q₂₁(N″) | | | |
| (1) | 39.03924(2) | 0.0001 | −0.0007 | (0) | 40.06471(5) | 0.0022 | 0.0016 |
| (2) | 38.52575(9) | 0.0016 | 0.0010 | (1) | 40.57113(5) | 0.0003 | −0.0001 |
| (3) | 38.0086(2) | 0.0018 | 0.0013 | (2) | 41.07680(3) | 0.0000 | 0.0000 |
| (4) | 37.48898(9) | 0.0018 | 0.0018 | (3) | 41.5787(1) | −0.0018 | −0.0016 |
| ^{R}R₁₁(N″) | | | | ^{R}R₂₂(N″) | | | |
| (0) | 39.6815(2) | 0.0013 | 0.0006 | (1) | 40.57882(3) | 0.0005 | 0.0002 |
| (1) | 39.9346(2) | 0.0009 | 0.0004 | (2) | 41.08966(2) | 0.0003 | 0.0005 |
| (2) | 40.1851(1) | 0.0003 | 0.0003 | (3) | 41.59675(10) | −0.0014 | −0.0009 |
| (3) | 40.4329(1) | −0.0007 | −0.0006 | (4) | 42.1041(2) | −0.0006 | 0.0010 |
| (4) | 40.68031(6) | 0.0001 | 0.0013 | (5) | — | — | — |
| (5) | 40.92336(9) | −0.0012 | −0.0000 | (6) | 43.10720(2) | −0.0037 | −0.0002 |

RaOD

| | | | | | | | |
|---|---|---|---|---|---|---|---|
| ^{P}P₁₁(N″) | | | | ^{P}P₂₂(N″) | | | |
| (1) | 27.871(1) | −0.0003 | −0.0005 | (2) | 27.752(2) | −0.0004 | 0.0005 |
| (2) | 27.403(2) | 0.0000 | 0.0001 | (3) | 27.511(8) | 0.0009 | 0.0020 |
| (3) | 26.931(3) | −0.0002 | −0.0002 | (5) | 27.016(4) | 0.0005 | 0.0014 |
| (4) | 26.456(4) | −0.0005 | −0.0001 | (9) | 25.988(2) | −0.0016 | −0.0001 |
| (5) | 25.978(1) | 0.0002 | −0.0002 | | | | |
| ^{P}Q₁₂(N″) | | | | ^{R}Q₂₁(N″) | | | |
| (1) | 27.8780(9) | −0.0007 | −0.0006 | (0) | 28.797(1) | 0.0001 | 0.0002 |
| (2) | 27.415(2) | −0.0001 | 0.0003 | (1) | 29.251(5) | 0.0001 | −0.0002 |
| (3) | 26.948(3) | 0.0006 | 0.0004 | (2) | 29.703(1) | 0.0005 | 0.0007 |
| (4) | 26.478(2) | 0.0002 | 0.0008 | (3) | 30.151(9) | 0.0007 | 0.0005 |
| (5) | 26.004(2) | 0.0000 | 0.0000 | (4) | 30.595(6) | 0.0001 | −0.0001 |
| | | | | (5) | 31.037(2) | −0.0001 | −0.0002 |
| | | | | (6) | 31.475(3) | −0.0009 | −0.0001 |
| ^{R}R₁₁(N″) | | | | ^{R}R₂₂(N″) | | | |
| (0) | 28.460(2) | −0.0002 | 0.0000 | (1) | 29.259(1) | 0.0003 | 0.0008 |
| (1) | 28.689(3) | −0.0001 | −0.0008 | (2) | 29.714(2) | −0.0002 | −0.0001 |
| (2) | 28.915(2) | −0.0004 | −0.0013 | (3) | 30.166(1) | −0.0010 | −0.0009 |
| (3) | 29.140(2) | 0.0007 | 0.0001 | (4) | 30.617(5) | 0.0003 | 0.0008 |
| (4) | 29.360(1) | 0.0008 | 0.0003 | (5) | 31.063(6) | 0.0000 | −0.0001 |
| | | | | (6) | 31.506(5) | −0.0007 | 0.0004 |

In Table 3, a) Line assignment: ^{ΔN}ΔJ_{F′F″}(N″). b) Observed transition wavenumber −15700 cm⁻¹. Parentheses indicate the 1σ parameter error on the line center determined from Voigt profile fit. Absolute calibration error on individual lines is ±60 MHz, defined by wavemeter reference uncertainty. c) The observed-calculated using optimized parameter from the effective Hamiltonian model. d) The observed-calculated using optimized parameter from the C²Σ⁺/Ã²Π mixed state perturbation model.

Survey spectroscopy on the RaOD

$${\tilde{X}}^{2} {Σ}_{1 / 2}^{+} - {\tilde{C}}^{2} {Σ}_{1 / 2}^{+}$$

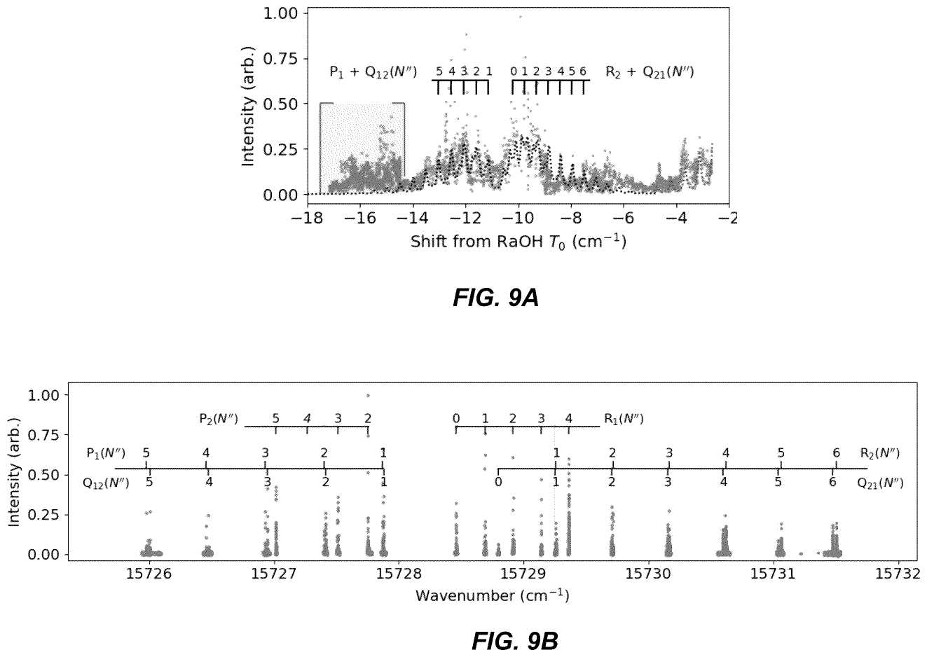

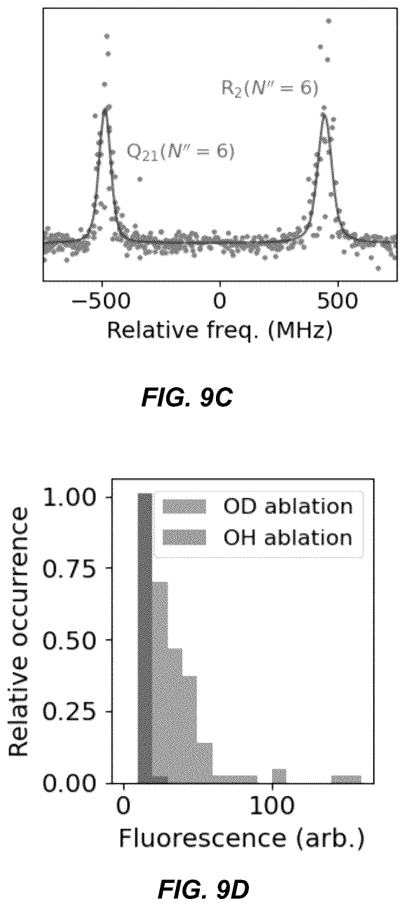

origin band utilized only the Δν~2.5 GHz linewidth pulsed dye laser, as the isotope-shifted band head could be predicted much more precisely given prior observations of the same transition in RaOH. Initial scans covering from 15719 cm-1 to 15741 cm-1 identified strong fluorescence signal at ~15729 cm-1, redshifted from RaOH by ~9 cm-1. A finer-grained scan around this region is shown in FIG. 9A. A narrow-linewidth laser was used to resolve the low-N lines in high-resolution, identifying a total of 32 spectral features. These features were detected and fit using the same methods for RaOH described above and are collected in Table 4, below. The extracted B0 and γ constants scale as expected for the replacement of H→D. Because the wavemeter system was not referenced to an absolute frequency standard, a global uncertainty of ±60 MHz applies to all line centers, limited by the calibration error of the helium-neon reference laser. This uncertainty should not affect the relative separation between lines as this dataset was taken over a short period of time.

TABLE 4
Table of expected intensity ratio of ^{P}Q₁₂(1) and ^{P}P₁₁(1)
lines as a function of total dipole moment (TDM) ratio.

| TDM Ratio | Intensity Ratio |
|---|---|
| T_{±1}/T₀ | ^{P}Q₁₂(1)/^{P}P₁₁(1) |
| 0.00 | 0.50 |
| 0.25 | 0.75 |
| 0.50 | 1.1 |
| 0.75 | 1.6 |
| 1.00 | 2.3 |
| Expt. | 1.5 |

To further identify these lines with RaOD, points in this region were probed while switching the ablation between the Al(OH)3 and Al(OD)3 co-targets. In the region near the band head, the signal depends entirely on ablation of the deuterated co-target (FIG. 9D). Because the Al(OD)3 target contains hydroxide groups from the PEG binder, the correlation decreases towards the blue side of the scan (from 15734 cm-1 onwards), owing to the presence of overlapping RaOH lines and vibrational overtones. Molecular fluorescence also relies on resonant ³P₁ excitation of Ra across the entire scan region, indicating the dependence on Ra-driven chemistry for molecule production.

The spectrum of the RaF

$${X}^{2} {Σ}_{1 / 2}^{+} ( {v}^{″} = 1 ) - {C}^{2} {Σ}_{1 / 2}^{+} ( {v}^{′} = 0 )$$

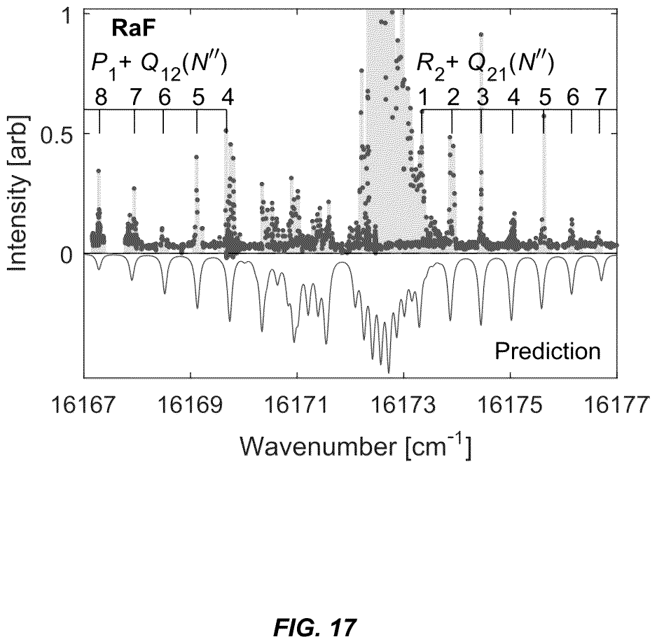

vibronic band system was recorded at medium-resolution (Δν~2.5) GHz pulsed dye laser linewidth. Fluorescence detection was performed on the strong (ν′=0)-(ν″=0) decay near 602 nm with optical filtering. As shown in FIG. 17 a total of 12 rotationally resolved features clear of the band head are recorded at this linewidth. The observations were fitted to a Voigt profile whose centers and standard errors are listed in Table 5.

TABLE 5
Medium-resolution (Δv~2.5 GHz) rotationally resolved features
$on the RaF {X}^{2} {\sum }_{1 / 2}^{+} ( 1 ) - {C}^{2} {\sum }_{1 / 2}^{+} ( 0 )$
band system resolved with pulsed dye excitation.

| Branches | Observation |
|---|---|
| P₁ + Q₁₂ (N″ = 8) | 16167.2938(2) |
| P₁ + Q₁₂ (N″ = 7) | 16167.9479(6) |
| P₁ + Q₁₂ (N″ = 6) | 16168.4890(1) |
| P₁ + Q₁₂ (N″ = 5) | 16169.7798(5) |
| P₁ + Q₁₂ (N″ = 4) | 16169.6773(2) |

band head

| | |
|---|---|
| R₂ + Q₂₁ (N″ = 1) | 16173.3392(3) |
| R₂ + Q₂₁ (N″ = 2) | 16173.9048(8) |
| R₂ + Q₂₁ (N″ = 3) | 16174.4530(5) |
| R₂ + Q₂₁ (N″ = 4) | 16175.0417(4) |
| R₂ + Q₂₁ (N″ = 5) | 16175.6246(1) |
| R₂ + Q₂₁ (N″ = 6) | 16176.1491(3) |
| R₂ + Q₂₁ (N″ = 7) | 16176.6699(2) |

In Table 5, the ground state spin-rotation splitting is below the laser linewidth, and two branch designators are therefore assigned to each observation. As with the high-resolution line list, feature centers were determined from Voigt profile fits to the fluorescence data. Parentheses reflect the standard error of the fit which was used for error weighting in Hamiltonian parameter determination. All values are in cm⁻¹.

At this resolution, ground state spin-rotation was not resolved, and therefore P₁+Q₁₂ as well as the R₁+Q₂₁ progression pairs are not distinguishable from each other in the spectra. However, ground state rotational parameters, including spin-rotation, for the X²Σ⁺(ν″=1) manifold of RaF were previously determined. For the band analysis described herein, X²Σ⁺ lower state parameters are held fixed to the literature values of in a Hamiltonian model of the X²Σ⁺(ν″=1)−C²Σ⁺(ν′=0) band. From this, fine structure parameters for the C²Σ⁺(ν′=0) excited state manifold were updated.

### Spectral Fitting

Two analyses of the high-resolution spectra were performed. There was no evidence of local perturbations or proton/deuteron magnetic hyperfine splitting. The data set was restricted to the lowest rotational levels and did not require the inclusion of centrifugal distortion terms. In the initial analysis, the energy levels for the \tilde{X}²Σ⁺ and \tilde{C}²Σ⁺ states were modeled using an effective Hamiltonian approach that included the rotational and spin-rotation terms in space-fixed convention:

$${\hat{H}}_{eff} = {\hat{H}}_{r o t} + {\hat{H}}_{S R} = B {\hat{N}}^{2} + γ \hat{N} \cdot \hat{S} , \qquad ( S1 )$$

where N=J−S. The energy level pattern of the \tilde{X}²Σ⁺ is that of a molecule near the Hund's case (b) limit, with the closely spaced rotational levels split by a small spin-rotation splitting, while the pattern of the \tilde{C}²Σ⁺ state is nearer to the Hund's case (c) limit. For generalizability, work was carried out in the Hund's case (a) basis |Λ, S, Σ, J, Ω for both states. The matrix elements in case (a) for the effective Hamiltonian terms (eq. S1) are:

$$〈 Λ , S , Σ , J , Ω \vert {\hat{H}}_{r o t} \vert Λ , S , {Σ}^{′} , J , {Ω}^{′} 〉 = {B}_{0} [ {δ}_{Σ , {Σ}^{′}} {δ}_{Ω , {Ω}^{′}} ( J ( J + 1 ) + S ( S + 1 ) - 2 ΩΣ ) - 2 {( - 1 )}^{J - Ω + S - Σ} {Σ}_{q} ( \begin{matrix}J & 1 & J \\ - Ω & q & {Ω}^{′}\end{matrix} ) ( \begin{matrix}S & 1 & S \\ - Σ & q & {Σ}^{′}\end{matrix} ) \sqrt{( J ( J + 1 ) ( 2 J + 1 ) S ( S + 1 ) ( 2 S + 1 )} ] . \qquad ( S2 )$$

$$〈 Λ , S , Σ , J , Ω \vert {\hat{H}}_{S R} \vert Λ , S , {Σ}^{′} , J , {Ω}^{′} 〉 = γ [ {δ}_{Σ , {Σ}^{′}} {δ}_{Ω , {Ω}^{′}} ( Ω Σ - S ( S + 1 ) ) + {( - 1 )}^{J - Ω + S - Σ} {Σ}_{q} ( \begin{matrix}J & 1 & J \\ - Ω & q & {Ω}^{′}\end{matrix} ) ( \begin{matrix}S & 1 & S \\ - Σ & q & {Σ}^{′}\end{matrix} ) \sqrt{( J ( J + 1 ) ( 2 J + 1 ) S ( S + 1 ) ( 2 S + 1 )} ] . \qquad ( S3 )$$

The most convenient representation of both the \tilde{X}²Σ⁺ and \tilde{C}²Σ⁺ states is in the parity-conserving Hund's case (a) basis, which is diagonal in Ĥ_{eff}:

$${ψ}^{\pm } = \frac{1}{\sqrt{2}} [ \vert η , Λ ; S , \sum ; J , Ω 〉 \pm {( - 1 )}^{J - S} \vert η , - Λ ; S , - Σ ; J , - Ω 〉 ] \qquad ( S4 )$$

where the “±” refers to the plus and minus parity, and η refers to all other quantum numbers. Ĥ_{eff} is an eigenoperator of these basis functions with plus parity energies, E⁽⁺⁾(J), and minus parity energies, E⁽⁻⁾(J), given by:

$${E}^{( \pm )} ( J ) = B ( J ( J + 1 ) + \frac{1}{4} ) \pm {( - 1 )}^{J - 1 / 2} B ( - J - \frac{1}{2} ) - γ ( - \frac{1}{2} \pm {( - 1 )}^{J - 1 / 2} {( J + \frac{1}{2} )}^{2} ) . \qquad ( S5 )$$

In the effective Hamiltonian analysis, weighted linear least squares fits of the 27 measured RaOH transition wavenumbers and the 32 measured RaOD transition wavenumbers of Table 4 were performed against Ĥ_{eff}. The weights were taken as the inverse of the square of the standard error of the lineshape fits, which are also given in the same tables. A similar analysis was performed for the RaF medium resolution lines, fixing the ground state parameters to values determined in as described earlier. For RaOH/D, the optimized B and γ parameters for the \tilde{X}²Σ⁺ and \tilde{C}²Σ⁺ states, the origin, T₀, and associated errors are presented in Table 6. The standard deviation of the fits of 0.0012 cm⁻¹ (RaOH) and 0.0005 cm⁻¹ (RaOD) are commensurate with estimated measurement uncertainty of approximately 0.001 cm⁻¹ and there are no systematic trends in the difference between the observed and predicted transition wavenumber which are given in Table 4. FIG. 10 depicts the two-dimensional statistical confidence regions up to 2σ for estimated parameters computed via F-test, which confirms that the effective model is well-behaved and the estimated parameters converge to global minima.

TABLE 6
Determined spectroscopic parameters for the \tilde{C}²Σ⁺(0, 0, 0) − \tilde{χ}²Σ⁺(0, 0, 0) band of
RaOH/D and the \tilde{C}²Σ⁺(ν′ = 1) − \tilde{χ}²Σ⁺(ν″ = 0) band of RaF in wavenumbers (cm⁻¹).

| | RaOH | | RaOD | | RaF | |
|---|---|---|---|---|---|---|
| | Eff. Ham.^{a} | Explicit (3 × 3)^{b} | Eff. Ham.^{a} | Explicit (3 × 3)^{b} | Eff. Ham.^{a} | Explicit (3 × 3)^{c} |
| B(\tilde{C}²Σ⁺) | 0.192810(23) | 0.191552(19) | 0.173750(21) | 0.169692(22) | 0.18890(19) | 0.18652(57) |
| γ(\tilde{C}²Σ⁺) | −0.25488(14) | — | −0.224787(97) | — | −0.4132(30) | — |
| M₁ | — | 0.22697(10) | — | 0.204299(54) | — | 0.34047(18) |
| E(\tilde{C}²Σ⁺) | — | 15338.47958(20) | — | 15325.54202(17) | — | 15747.993(23) |
| B(\tilde{χ}²Σ⁺) | 0.193944(19) | 0.193929(24) | 0.175333(19) | 0.175392(17) | 0.19092^{d} | 0.19092^{d} |
| γ(\tilde{χ}²Σ⁺) | 0.00504(12) | 0.004960(15) | 0.004759(56) | 0.00470(7) | 0.00581^{d} | 0.00581^{d} |
| T₀ | 15739.42204(21) | — | 15728.22464(24) | — | 16171.9194(79)^{†} | — |
| Std. of fit | 0.0012 | 0.0009 | 0.0005 | 0.0006 | 0.041 | 0.040 |

In Table 6, the values in parentheses denote the 1σ statistical error on the estimated parameters from least squares fitting. a) Obtained using the Hamiltonian given in Eq. (S1). b) Obtained using energies by Eqs. (S6): A=1450 cm⁻¹, M₂=1025 cm⁻¹, and E(Ã²Π)=13845 cm⁻¹. E(\tilde{C}²Σ⁺) and E(Ã²Π) are the energies of the interacting excited states in the absence of the spin-orbit interaction. c) Obtained using energies by Eqs. (S6). A=1450 cm⁻¹, M₂=1025 cm⁻¹, and E(Ã²Π)=14420 cm⁻¹. d) Fixed at values determined by. (†) referenced relative to X²Σ⁺(ν″=1)−C²Σ⁺(ν′=0) transition.

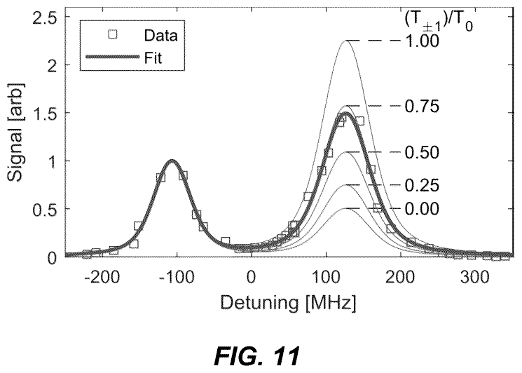

The eigenvectors and energies from this effective Hamiltonian model were used to predict the spectrum of RaOH/D. The intensities were computed by the square of the amplitude of the Hund's case (a) transition moment matrix element, scaled by the ground state rotational occupation described by a Boltzmann factor. Although the predicted spectra were in overall good agreement with the observations, there were noticeable discrepancies in the predicted relative intensities. For example, the RaOH satellite ^{P}Q₁₂(1) (ν=15739.0392 cm⁻¹) line was predicted to be approximately a factor of two less intense than the ^{P}P₁₁(1) (ν=15739.0314 cm⁻¹) line whereas it was observed to be a factor of around 1.5 times more intense, as seen in FIG. 11. One reason for the apparent inconsistency may be due to the assumption that the excited state is a pure ²Σ⁺ electronic state. As evidenced by the large and negative spin-rotation fit parameter, γ=−0.25488(14) cm⁻¹, which gives rise to large spin-rotation splitting (ρ-doubling), the excited |Ω|=½ state is in fact a ²Σ⁺/²Π_{1/2} admixture, analogous to other related molecules such as YbOH and BaOH.

Motivated by the discrepancies observed, a second analysis modeled the energies and wavefunctions of the “\tilde{C}²Σ⁺” state by explicitly including interaction with the yet-to-be-detected Ã²Π_{1/2} state. This analysis aimed to improve the prediction of the relative intensities, thereby gaining insight into the spin-orbit-induced excited state mixing. The Ã²Π_{1/2} state is predicted to be 3031 cm⁻¹ below the \tilde{C}²Σ⁺ state. In the zeroth order picture, the levels of the Ã²Π_{1/2} state are systematically shifted to lower energy and those of the \tilde{C}²Σ⁺ state shifted higher by spin-orbit and spin-electronic interactions. The rate of the shifting of the positive and negative parity levels of both the Ã²Π_{1/2} and \tilde{C}²Σ⁺ states are slightly different, giving rise to Λ-doubling in the Ã²Π_{1/2} state and ρ-doubling in the \tilde{C}²Σ⁺ state. In this second approach, rotational energies were obtained by diagonalizing a 3×3 matrix constructed in a parity conserving Hund's case (a) function for the ²Σ⁺, ²Π_{1/2}, and ²Π_{3/2} electronic states. The complete set of matrix elements were tabulated by Brown and Carrington and those relevant to the present analysis are reproduced here for convenience:

$$( {}^{2} {\prod }_{3 / 2} ( \pm ) {\vert \hat{H} \vert}^{2} {\prod }_{3 / 2} ( \pm ) 〉 = E {(}^{2} \prod ) + \frac{1}{2} A + B [ J ( J + 1 ) - 7 / 4 ] , \qquad ( S6 )$$

$$( {}^{2} {\prod }_{1 / 2} ( \pm ) \vert \hat{H} \vert {}^{2} {\prod }_{1 / 2} ( \pm ) 〉 = E ( {}^{2} \prod ) - \frac{1}{2} A + B [ J ( J + 1 ) + 1 / 4 ] ,$$

$${}^{2} {\sum }_{1 / 2} ( \pm ) \vert \hat{H} \vert {}^{2} {\sum }_{1 / 2} ( \pm ) 〉 = E ( {}^{2} \sum ) + B [ J ( J + 1 ) + 1 / 4 ] \pm {B ( - 1 )}^{J - 1 / 2} ( J + 1 / 2 ) ,$$

$$( {}^{2} {\prod }_{1 / 2} ( \pm ) \vert \hat{H} \vert {}^{2} {\sum }_{1 / 2} ( \pm ) 〉 = {M}_{2} ∓ {{M}_{1} ( - 1 )}^{J - 1 / 2} ( J + 1 / 2 ) .$$

In eqs. S6, M₁= [symbol] ²Π|BL⁺|²Σ [symbol] and M₂= [symbol] ²Π(A/2+B)|L⁺|²Σ [symbol] are the spin-electronic and spin-orbit mixing matrix elements, E(²Π) and E(²Σ) are the unperturbed energies, A is the spin-orbit parameter, and B is the rotational parameter. There is currently insufficient information about the excited states of RaOH to perform a global fit to determine all the parameters in eqs. S6. In fitting the observed spectra of RaOH and RaOD to this model, the M₁, B, and E(²Σ) parameters of the \tilde{C}²Σ⁺/Ã²Π mixed states were optimized and E(²Π), A, and M₂ parameters were fixed to estimated values. The unperturbed energy of the Ã²Π state, E(²Π), was constrained to 13845 cm⁻¹, which was the value that reproduced the predicted splitting of 3031 cm⁻¹ between the Ã²Π_{1/2} and \tilde{C}²Σ⁺ states of RaOH. Estimates for A and M₂ for the analysis were obtained by using the experimentally measured energies of the Ã²Π_{1/2} (13288 cm⁻¹), Ã²Π_{3/2} (15355 cm⁻¹), and \tilde{C}²Σ⁺ (16620 cm⁻¹) states of isoelectronic RaF. If it is assumed that the Ã²Π and \tilde{C}²Σ⁺ of RaF and RaOH arise from an electronic configuration with a lone unpaired electron in a 5p orbital, then:

$$〈 {}^{2} \prod \vert {L}^{+} \vert {}^{2} \sum 〉 \approx ( 5 {p}_{\pm 1} \vert {L}^{+} \vert 5 {p}_{0} 〉 = \sqrt{2} ⇒ {M}_{2} \approx \frac{\sqrt{2}}{2} A . \qquad ( S7 )$$

With this assumption, the relative energies of three RaF states can be approximately reproduced using the 3×3 matrix approach with spin-orbit parameter A=1450 cm⁻¹ and ²Π−²Σ energy splitting ΔE=1400 cm⁻¹. A non-linear weighted least-squares fit of the 27 observed transition wavenumbers of RaOH and 32 observed transition wavenumbers of RaOD given in Table 4 were performed to determine optimized B and γ values for the \tilde{X}²Σ⁺, as well as B, M₁, and E(²Σ) for the \tilde{C}²Σ⁺/Ã²Π mixed states. The optimized parameters and associated errors are given in Table 5. The standard deviations of the fits are 0.009 cm⁻¹ (RaOH) and 0.007 cm⁻¹ (RaOD) which were commensurate with the estimated measurement uncertainties. The difference between the observed and predicted transition wavenumbers, which are given in Table 4, are nearly identical to those for the effective Hamiltonian model.

The \tilde{C}²Σ⁺/Ã²Π state mixing observed was significant. The excited state eigenvectors for energy levels associated with the observed transitions are approximately 87% ²Σ⁺ and 13% ²Π character, which is consistent with the ab initio prediction of the composition of the excited state of RaF. The eigenvectors from the mixed \tilde{C}²Σ⁺ and Ã²Π state analysis were used to predict the spectra. The Hund's case (a) transition moment matrix elements are:

$$( Λ , S , \sum , J , Ω \vert {T}_{q}^{1} ( μ ) \vert {Λ}^{′} , S , \sum , {J}^{′} , {Ω}^{′} 〉 = {( - 1 )}^{J - Ω} \sqrt{( 2 J + 1 ) ( 2 {J}^{′} + 1 )} ( \begin{matrix}J & 1 & {J}^{′} \\ - Ω & q & {Ω}^{′}\end{matrix} ) 〈 Λ \vert {T}_{q}^{1} ( μ ) \vert {Λ}^{′} 〉 . \qquad ( S8 )$$

The q=0 components of the transition moment operator are responsible for the parallel (ΔΛ=0) ²Σ⁺↔²Σ⁺ transition and the q=±1 components the perpendicular (ΔΛ=±1) ²Π↔²Σ⁺ transitions. The effective Hamiltonian assumes a pure ²Σ⁺ character and thus excludes the ²Π↔²Σ⁺ component. As can be seen from the predicted ^{P}Q₁₂(1) and ^{P}P₁₁(1) lines (FIG. 11) the relative intensities are reproduced when

$${T}_{\pm 1}^{1} ( μ ) \approx 0.7 \times {T}_{0}^{1} ( μ ) .$$

### Spin-Rotation Coupling

The electron spin-rotation interaction contributes a bilinear term γN·S to the molecular energy. For the \tilde{X}²Σ⁺ electronic ground states of RaOH/D, γ corresponds to the splitting of the rotational ground states of the Ω=±½ manifold due to the L-uncoupling interaction BL_{±}. Specifically, the L-uncoupling interaction mixes the Ω=±½ components and induces a splitting of the value γ between

$$\frac{1}{\sqrt{2}} ( \vert Ω = - 1 / 2 〉 + \vert Ω = - 1 / 2 〉 ) and \frac{1}{\sqrt{2}} ( \vert Ω = 1 / 2 〉 - \vert Ω = - 1 / 2 〉 ) .$$

For ab initio electronic structure calculations of γ, a small magnetic field was included to evenly mix the Ω=±½ components and obtain the parity states

$$\frac{1}{\sqrt{2}} ( \vert Ω = 1 / 2 〉 \pm \vert Ω = - 1 / 2 〉 ) .$$

The L-uncoupling interaction was then added as a finite field to obtain the energy splitting. These calculations were performed using the CFOUR program package. The wave functions were calculated using the electron attachment version of equation-of-motion coupled-cluster singles and doubles (EOMEA-CCSD) method. The relativistic exact two-component (X2C) approach with atomic mean-field (AMF) integrals based on the Dirac-Coulomb-Breit Hamiltonian [the X2CAMF(DCB) scheme] was used to account for relativistic effects. The X2CAMF scheme features variational treatments of scalar-relativistic and spin-orbit coupling effects in the spinor representation.

A good agreement between the X2C-CC calculations and measurements for the \tilde{X}²Σ⁺ ground state spin rotation parameters of RaF and RaOD/H was observed. The X2CAMF-EOMEA-CCSD value of 165 MHz for the \tilde{X}²Σ⁺ state of RaOH agrees well with the measured value of 151(3) MHz. The corresponding X2CAMF-EOMEA-CCSD value for RaOD was 149 MHz, in good agreement with the measured value of 143(2) MHz. Similarly, the X2CAMF-EOMEA-CCSD value of 187 MHz for RaF was also in good agreement with the measured ground state literature value of 175 MHz.

Agreement between calculation and measurement for the excited \tilde{C}²Σ⁺ states of RaF and RaOH was more mixed. The X2CAMF-EOMEA-CCSD computed value of −13443 MHz for RaF was in reasonable agreement with the measured value of −12388 MHz. On the other hand, the computed values of −13574 MHz for RaOH and −12342 MHz for RaOD were in qualitative agreement with the measured values of −7641(4) MHz and −6739(3) MHz, but exhibit substantial overestimation of the absolute magnitudes. The measured value for RaOH was around half of that for RaF, while the computed values for RaOH was similar to that of RaF.

These results suggest that certain differences between the RaOH and RaF electronic structure have not been fully captured by the EOMEA-CCSD calculations. An EOMEA-CCSD calculation uses the closed-shell ground state of the cation as the reference. The calculation accurately takes into account the contributions from the electron-attached states differing from the reference state in a single electron attachment. However, contributions from configurations differing from the reference by more than a single attachment were accounted for less accurately. Without being bound by any theory, it may be hypothesized that the spin-rotation constants of the \tilde{C}²Σ state in RaOH/RaOD have more contributions from charge-transfer excited states than in RaF. The lowest charge-transfer excited state with Ω=½ in RaOH or RaOD, originating from a transition from an oxygen 2p orbital to Ra 7s orbital, was around 5.3 eV above the ground state. They are substantially lower than the charge-transfer excited states in RaF with an excitation from fluorine 2p orbital to Ra 7s orbital, which was around 6.8 eV above the ground state. Alternatively, the values for the spin-rotation constants of the \tilde{C}²Σ state could be affected by coupling with nearby vibronic states, for example as in BaOH/BaOD where a factor of two difference between spin-rotation constants between the \tilde{B}²Σ⁺(000) and \tilde{B}²Σ⁺(100) states was observed.

In addition to the finite field calculations, an estimate of the spin rotation parameters was performed for the \tilde{C}²Σ states via perturbation theory and obtain qualitatively consistent results. For this computation, you may assume that the γN·S effective interactions arise primarily as a consequence of the second order couplings described in eq. S9. Assuming a single perturber, the excited spin rotation constant draws leading second-order contributions from the L-uncoupling and microscopic spin-orbit terms of the rotational Hamiltonian:

$${{γ}_{S R}^{( 2 )} = 2 \vert ( {v}^{″} \vert {v}^{′} 〉 \vert}^{2} ( {}^{2} {\sum }_{- 1 / 2}^{+} \vert BL\_ \vert 2 {}^{2} {\prod }_{1 / 2} 〉 \times \frac{{〈}^{2} {\prod }_{1 / 2} \vert {\sum }_{i} {a}_{i} {l}_{i}^{+} {s}_{i}^{-} \vert {}^{2} {\sum }_{1 / 2}^{+} 〉}{E {(}^{2} {\prod }_{1 / 2} ) - E {(}^{2} {\sum }_{1 / 2}^{+} )} , \qquad ( S9 )$$

where | [symbol] v″|v′ [symbol] |² is the Franck-Condon factor between the Ã²Π_{1/2} and excited

$${\tilde{C}}^{2} {\sum }_{1 / 2}^{+}$$

manifolds. Taking the standard approximations,

$$〈 {}^{2} \prod \vert {\sum }_{i} {a}_{i} {l}_{i}^{+} {s}_{i}^{-} \vert {}^{2} {\sum }^{+} 〉 \approx A \sqrt{l ( l + 1 )} / 2 ,$$

[symbol]

²Σ⁺|BL₋|²Π [symbol] ≈B_{Σ}\sqrt{l(l+1)}, [symbol] v″|v′ [symbol] =1, and l=1, S10 is obtained:

$${γ}_{S R}^{( 2 )} \approx \frac{2 l ( l + 1 ) ( A / 2 ) {B}_{\sum }}{{E}_{\prod } - {E}_{\sum }} = - \frac{2 A {B}_{\sum }}{{E}_{\prod } - {E}_{\sum }} . \qquad ( S10 ) .$$

Table 7 shows a list of inputs used to compute the value of γ using eq. S10. Alternatively, this relationship can be used to perform a coarse, semi-empirical estimate for the location of the yet-to-be-observed Ã²Π_{1/2} electronic manifold in RaOH, which is anticipated to support highly diagonal optical cycling transitions. Due to the expected similarity in ligand field effects, one may utilize A_{Σ,Π}~[E(²Π_{3/2})−E(²Π_{1/2})]2~1000 cm⁻¹ from observed RaF splittings. Combined with fine structure parameters of the RaOH \tilde{C}²Σ⁺ state, this simplified perturber model implies the location of the Ã²Π_{1/2} state ~3000 cm⁻¹ below the \tilde{C}²Σ⁺ origin, consistent with reference ab initio calculations.

TABLE 7
Values used for the perturbative estimate of the spin rotation
parameters (γ) in the \tilde{X} and \tilde{C}
states of RaOH/D reported in the main text.

| | A (cm⁻¹) | B_{Σ} (MHz) | E_{Π} (cm⁻¹) | E_{Σ}(cm⁻¹) | γ (MHz) |
|---|---|---|---|---|---|
| RaOH(\tilde{C}) | 1412 | 5783 | 13778 | 15673 | −8618 |
| RaOD(\tilde{C}) | 1412 | 5226 | 13778 | 15673 | −7787 |

In Table 7, the energies E_{Π} are taken as the calculated spin-orbit free equilibrium energy of the ²Π electronic configuration, E_{Σ} is taken as the equilibrium energies of the \tilde{X}²Σ and \tilde{C}²Σ states for the respective manifolds calculated. A is the spin-orbit parameter, which is obtained from EOM-X2C-CC calculations.

### Bond Length and Geometry

The measured high-resolution parameters also enable direct determination of molecular geometries. Consistent with isoelectronic metal hydroxide (MOH) systems and electronic structure calculation, the spectral pattern for RaOH/D indicates a C_{∞ν} linear geometry. Vibrationally averaged bond lengths (r₀) were computed using the RaOH/D rotational constant ratios and the effective Hamiltonian parameters listed in Table 5. Ground \tilde{X} state parameters are determined via isotope substitution calculation, where an identical geometry between RaOH/D and neglect differential zero-point vibrational energy (ZPE) effects. This is accomplished by solving eqs. S11 and S12 for r_{0(Ra—O)} and r_{0(O—H)}:

$${B}_{RaOH} = \frac{h}{8 {π}^{2} c} \frac{{m}_{Ra} + {m}_{O} + {m}_{H}}{\begin{matrix}{m}_{Ra} {m}_{O} {r}_{0 ( Ra - O )}^{2} + {m}_{O} {m}_{H} {r}_{0 ( O - H )}^{2} + \\ {m}_{Ra} {{m}_{H} [ {r}_{0 ( Ra - O )} + {r}_{0 ( O - H )} ]}^{2}\end{matrix}} , \qquad ( S11 )$$

$${B}_{RaOD} = \frac{h}{8 {π}^{2} c} \frac{{m}_{Ra} + {m}_{O} + {m}_{D}}{\begin{matrix}{m}_{Ra} {m}_{O} {r}_{0 ( Ra - O )}^{2} + {m}_{O} {m}_{D} {r}_{0 ( O - H )}^{2} + \\ {m}_{Ra} {{m}_{D} [ {r}_{0 ( Ra - O )} + {r}_{0 ( O - H )} ]}^{2}\end{matrix}} , \qquad ( S12 )$$

In the excitation to the \tilde{C} state, the RaOD rotational constant shifts by a larger amount compared to RaOH, likely a consequence of changes to vibronic couplings induced by ZPE shifts. Therefore, the RaOH and RaOD excited state geometry calculations were treated separately and only computed the shift to the Ra—O bond length from the excited state rotational constant, holding O—H fixed to the ground state.

Table 8 lists a summary of ground and excited state bond lengths calculated from experiment and their comparison to values computed from relativistic EOM-CC theory. The scalar-relativistic EOMEA-CCSD calculations of structural parameters have used systematically enlarged TZ, QZ, and 5Z basis sets to treat basis-set effects. The scalar-relativistic effects have been taken into account using the spin-free exact two-component theory in its one-electron variant (the SFX2C-1e scheme). The spin-orbit corrections have been included as the differences between the X2CAMF and SFX2C-1e results obtained using the TZ basis. The computations of equilibrium structures have been greatly facilitated by the implementation of analytic SFX2C-1e and X2CAMF-EOM-CCSD gradients. Detailed results are summarized in Table 9.

TABLE 8
Experimental values for vibrationally averaged bond lengths
(r₀) of RaOH/D determined via isotope substitution and
comparison to theory values from EOM-X2C-CC calculation.

| | Experiment | | Theory | |
|---|---|---|---|---|
| | r₀(Ra—O) | r₀(O—H/D) | rₐ(Ra—O) | rₐ(O—H/D) |
| RaOH(\tilde{X}) | 2.2791(1) | 0.9278(2) | 2.2795 | 0.9213 |
| RaOD(\tilde{X}) | | | 2.2780 | 0.9304 |
| RaOH(\tilde{C}) | 2.2861(2) | (fixed) | 2.2861 | 0.9280 |
| RaOD(\tilde{C}) | 2.2902(2) | (fixed) | 2.2846 | 0.9352 |

In Table 8, all data is given in angstroms (Å). Parentheses indicate 1σ statistical uncertainties propagated from the least-squares effective Hamiltonian fit. Systematic uncertainties due to neglecting differential zero-point vibrational energy shifts between RaOH and RaOD are expected at similar levels (~10⁻³-10⁻⁴ Å). For calculation of the excited \tilde{C} state bond lengths, r₀(O—H/D) was held fixed. The theory values for vibrationally averaged bond lengths rₐ were obtained by augmenting the computed equilibrium bond lengths with vibrational corrections calculated at the second-order vibrational perturbation theory.

TABLE 9
The EOMEA-CCSD/TZ, QZ, and 5Z bond lengths (in
Å) for RaOH were calculated using the SFX2C1e
scheme to treat scalar-relativistic effects.

| | \tilde{X}²Σ | | \tilde{C}²Σ | |
|---|---|---|---|---|
| | rₑ(Ra—O) | rₑ(O—H/D) | rₑ(Ra—O) | rₑ(O—H/D) |
| TZ | 2.2915 | 0.9533 | 2.2951 | 0.9532 |
| QZ | 2.2820 | 0.9519 | 2.2881 | 0.9519 |
| 5Z | 2.2787 | 0.9515 | 2.2866 | 0.9516 |
| ∞Z | 2.2752 | 0.9511 | 2.2851 | 0.9512 |
| +ΔSOC | 2.2703 | 0.9510 | 2.2767 | 0.9512 |

The spin-orbit coupling corrections (ΔSOC) were obtained as the difference between the X2CAMF and SFX2C-1e-EOMEA-CCSD/TZ results. These computed equilibrium structures correspond to equilibrium rotational constants of 5845 MHz, 5813 MHz, 5273 MHz, and 5245 MHz for the X²Σ state of RaOH, C²Σ state of RaOH, X²Σ state of RaOD, and C²Σ state of RaOD. Augmentation of these Bₑ values with vibrational corrections obtained from second-order vibrational perturbation theory calculations give the theoretical B₀ values.

### Atom Number Density

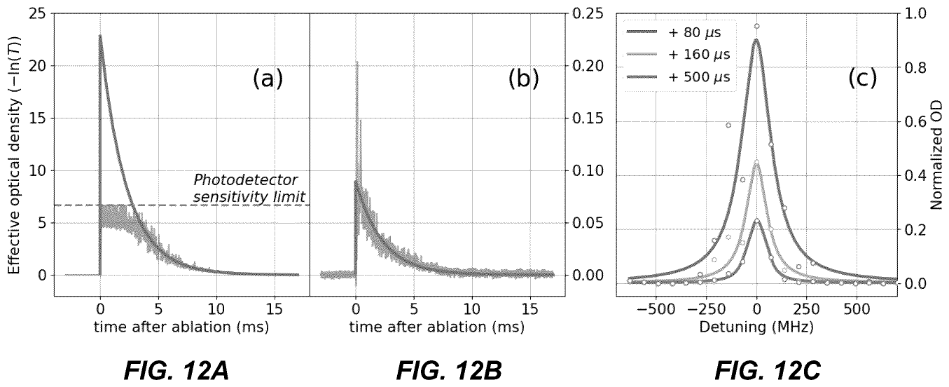

Following ablation of the drop casted target, Ra optical densities (OD) were monitored in real-time via atomic absorption on the ¹S₀−¹P₁ transition at 483 nm. The relationship between transmission (T) and absorbed density n is given by the Beer-Lambert Law:

$$n ( t ) = - \frac{ln [ T ( t ) ]}{{σ}_{a b s} L} = \frac{O D}{{σ}_{a b s} L} \qquad ( S13 )$$

where σ_{abs} is the absorption cross section of the ¹S₀-¹P₁ transition and the absorption length is set by the geometry of the buffer gas cell L=89 mm. For an absorption line where the Doppler width (Γ_{D}) is much larger than the radiative linewidth (Γ_{rad}), the cross section σ_{abs} is

$${σ}_{a b s} = \frac{\tilde{g} {λ}^{2}}{4 \sqrt{2 π}} \frac{{Γ}_{r a d}}{{Γ}_{D}} \qquad ( S14 )$$

where in the present case Γ_{rad}~2π×26 MHz, λ=483 nm, and the degeneracy fraction \tilde{g}=(2J′+1)/(2J″+1). Post-thermalization, the width settles to Γ_{D}~2π×100 MHz, as depicted in FIG. 12C, set mostly by Doppler broadening.

In the apparatus, ablation energies and spot sizes are configured such that majority of material on the drop casted Ra target is removed during the first few ablation shots at each new raster position (see FIGS. 3A-3D). These initial ablation shots produce peak atomic densities that are sufficiently high to be strongly opaque to the probe laser for several milliseconds (see FIGS. 12A-12C), with transmission below the minimum resolution (~one part in 10⁵) of the photodetector system. To interpolate peak OD beyond this detection limit, a simple exponential decay, n(t)=A·Exp(−k·(t−t₀)), was fit to weaker absorption traces taken from repeated shots on the same ablation site where the laser probe was not strongly blocked by the atomic absorption, as shown in FIG. 12B. The decay constant k, which is directly related to the atom diffusion time and should be the same between ablation pulses, was held fixed for a subsequent decay fit of the high-density absorption traces that are initially opaque.

By interpolation, an estimate of the peak optical densities during initial shots on the ablation raster to be ~23, as shown in FIG. 12A. Given an initial Doppler width of ~2π×400 MHz, this gives a peak atom density in the range of ~0.5-1×10¹¹ atoms cm⁻³. To extend this to a total atom number, an assumption was made that post-ablation the atoms rapidly fill the cell ballistically before diffusing to the walls. This model is consistent with the approximate static helium density (~5×10¹⁵ cm⁻³) inside the cell and prior diffusion studies of closed buffer gas cells. Given a total cell volume of 48 cm³, an inference of the total atom yield on the order of ~10¹² Ra atoms vaporized per ablation shot.

### Molecule Number Estimate

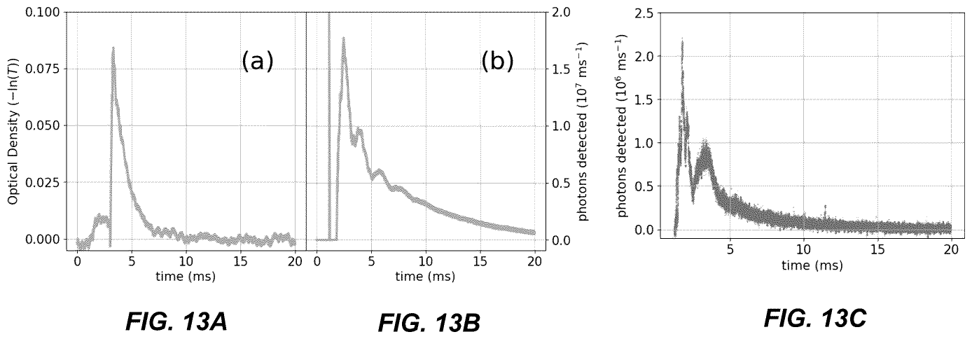

The interpolation of molecule number from laser-induced fluorescence signals requires understanding the light collection efficiencies of the optical system and expected photons per emitter. These factors were estimated quasi-empirically by calibrating to signals generated with dense clouds of stable isotope molecules, where fluorescence signals can be directly referenced to density measurements performed via laser absorption. FIGS. 13A-13C depict ¹⁷⁴YbOH absorption (FIG. 13A) and fluorescence (FIG. 13B) traces recorded on the \tilde{X}²Σ⁺-Ã²Π_{1/2}^{P}Q₁₂(N″=1) rotational transition at 17323.5669 cm⁻¹ under identical ablation and production conditions.

The total photon flux on the fluorescence detectors can be readily calculated from the photomultiplier tube (PMT) quantum efficiencies and gain factors. The Hamamatsu H13543-20 PMT module used for fluorescence detection has a cathode radiant sensitivity of 70 and 65 mA/W for the 595 nm and 660 nm wavelengths used for YbOH and RaOH off-diagonal detection, respectively. Following corrections for PMT gain and filter transmission efficiencies, a peak detection rate of at 1.6×10⁷ photons ms⁻¹ and 2×10⁶ photons ms⁻¹ and a total photon flux of 6.9×10⁷ and 3.6×10⁶ integrated over the 20 ms pulse for YbOH and RaOH, respectively was estimated, as depicted in FIG. 9C.

Extrapolating the detected photon number to molecule number requires considering multiple rate effects on the internal state population of the molecule: the excitation rate from the probe laser, the decay rates (with branching ratios) from the excited state, the diffusion time of the molecules out of the probe laser beam, as well as rotational remixing in the ground state that may be induced by helium collisions in the buffer gas environment. In the limit where the optical excitation rate and rotational remixing rate are fast relative to the diffusion time, the expected number of photons emitted in the detected wavelength range per molecule is ~1, keeping in mind that a photon will only be detected if the molecule decays into a vibrationally excited state which can therefore scatter no more photons. Excited vibrational states will relax back down to the ground vibrational state on a timescale too slow to be relevant.

Rotational remixing may be less trivial. If a molecule decays into a rotational state not addressed by the laser, it will stop scattering photons, but collisional remixing of rotational states is not negligible on these timescales. The probability that a molecule will decay down to a different rotational state in the ground vibrational state is D≈1−(1−F)R, where F is the probably of decaying into a different vibrational state and R is the rotational branching ratio (Hönl-London factor). F<<1 was utilized for YbOH and RaOH, and while R is branch dependent it is typically ≈⅓. Thus, typically there is a rotational state change every few photon scatters, and the photon scattering rate is limited by ~Γᵣₑₘᵢₓ, the rate of rotational remixing, in the limit where this rate is much slower than the excitation rate for a molecule resonantly interacting with the driving laser. Therefore, the rate of detecting photons, which must arise from vibrational state changing decays, is ΓᵣₑₘᵢₓF. If this timescale is less than the diffusion timescale τ_{diffusion}, that is, the length of time needed for the molecules to diffuse to the cell walls where they are lost, then there are multiple opportunities to detect a photon.

Some specific numbers are F_{YbOH}~9.11% and F_{RaOH}~1.23% for the branching ratios to off-diagonal vibrational detection channels. Given a steady-state helium density of ~5×10¹⁵ cm⁻³, a molecule-helium cross section of σ~5×10⁻¹⁴ cm², and relative velocity v=\sqrt{8k_{b}T/πμ}~200 m/s, an estimate of the mean time between diffusive helium-molecule collisions may be τ_{c}=[r̅σv]⁻¹~0.2 μs. Typical expectations would imply 10-100 collisions before a rotational state change, indicating a mean time of ~(2-20) μs before collisionally induced rotational state changes and a rotational remixing rate on the order of Γᵣₑₘᵢₓ~(5-50)×10³ s⁻¹. This implies that the expected photon number per molecule [symbol] n [symbol] approaches 1 as τᵣₑₘᵢₓ~0.01-0.01 ms for YbOH detection and τᵣₑₘᵢₓ~1-10 ms for RaOH detection. These values are comparable to or smaller than the measured molecular diffusion τ_{diffusion} through the probe laser, which suggests that ratio of detected molecules to detected photons in FIGS. 13A-13C was close to unity.

Ray tracing optics simulation of the cell and detector geometry indicates an optical collection efficiency of ~1% from a point source at the focal point of the cell lens to the PMT detector. For the YbOH data, this indicates a total number of 7×10⁹ molecules addressed by the fluorescence probe. The beam waist radius was ~1.5 mm at the focal plane, which traces a cylindrical cross section that was about 40× smaller from the ¾ inch diameter bore of the cell. Assuming that the molecules are uniformly distributed through the radial extent of the cell, total molecule number of 2×10¹¹ YbOH molecules can be estimated. For YbOH, the fluorescence molecule numbers were estimated by comparing to absorption values recorded under the same production conditions. We used eq. S13 and the earlier procedure for atom density calculation, Γ_{rad}~2π×7.95 MHz and the initial Doppler broadening at the peak to be ~400 MHz. The peak density was therefore 1.8×10⁹ molecules cm⁻³, implying a total number of 8×10¹⁰ molecules inside the cell, which is within a factor of unity of the initial fluorescence estimate.

Next, the same calculations are applied to the RaOH data, recorded on the first spot of a new raster position. Given a pulse integrated count of 3.6×10⁶ photons and fast collisional remixing, the optical collection efficiencies imply a total of 3.6×10⁸ molecules addressed by the laser probe. Using the same beam waist, this yields an estimated total molecule number of about 10¹⁰ distributed through the full cell volume. Incidentally, this is consistent with ~1% chemical conversion efficiency from 10¹² atoms off of a new raster spot computed in the earlier section.

### Example 3. Production and Spectroscopy of Cold Radioactive Molecules

### Methods

Cold gas-phase radioactive atoms and molecules were produced inside a copper cryogenic buffer gas cell approximately 48 cm³ in volume, which was held at a base temperature between 4 K and 7 K by a commercial closed-cycle cryocooler. The geometry and optical paths of the cryogenic cell are depicted in FIG. 1C. First, atomic and molecular precursors were vaporized by laser ablation of solid targets. Next, molecules were formed by optically driven chemical reactions between radium atoms and reagents. Finally, laser-induced fluorescence from tunable lasers was collected onto a photodetector to measure molecular spectra. These steps are described in detail below.

Within the cell, atomic and molecular precursors were ablated by focused, nanosecond 532 nm Nd:YAG lasers delivering 5-20 mJ of energy per pulse, depending on the target. Molecule production occurs via ablation of separate targets for the radioisotope and the ligand species, allowing for species-selective production by switching between targets in-situ. Radioisotope targets containing 10-50 μCi (0.37-1.85 MBq, 44-221 nmol) of radium chloride (RaCl₂) or nitrate (Ra(NO₃)₂) salts were fabricated in-house via manual pipetting (“drop casting”) of weakly acidic aqueous salt solution onto a heated gold surface. A small amount of xylitol was dissolved into the solution to improve ablation target consistency and adhesion following evaporation. Reagent “co-targets” are solid pellets formed by hydraulic pressing of fluoride-, hydroxide-, or deuteroxide-containing powders. Production of different molecules was achieved by steering the ablation laser to specific co-targets, of which there can be many (ten or more) in a single cell (FIG. 1C), with significant chemical diversity, limited only by the available space on the target plate.

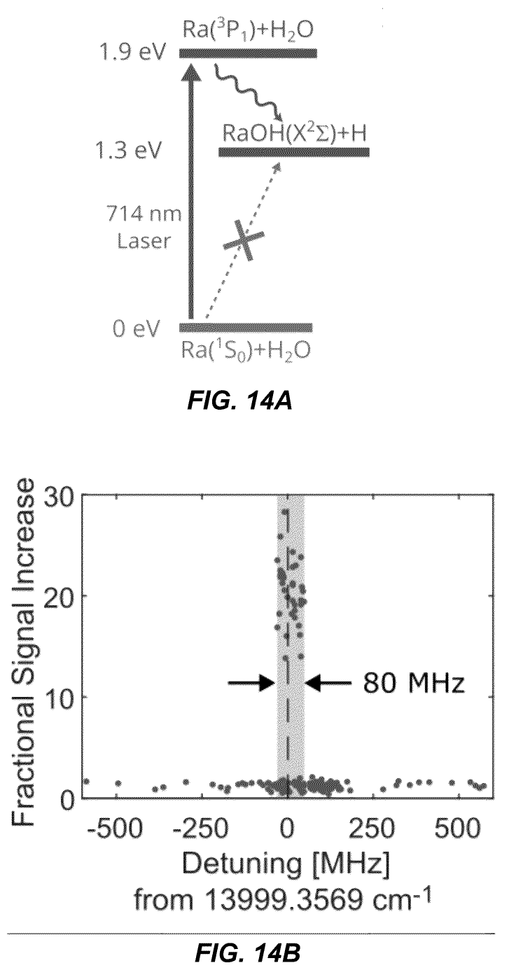

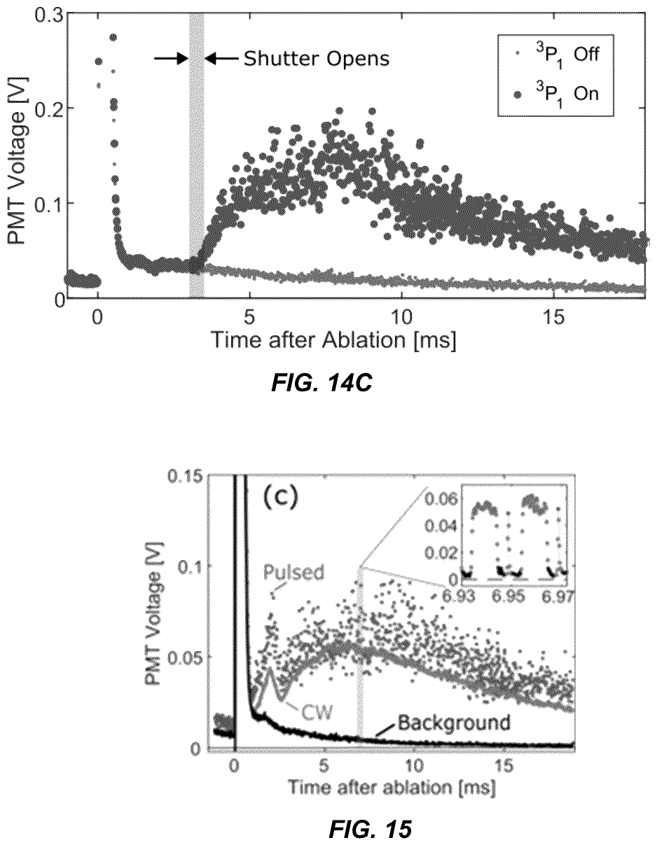

After ablation, the gas-phase atomic and molecular products rapidly cool to cryogenic temperatures via collisions with the helium buffer gas. This means that many possible chemical reactions, which would form the desired molecules, become energetically forbidden, stifling molecule production (see FIG. 14A). To overcome this, radium atoms are excited from the ¹S₀ ground state into the ³P₁ metastable state (λ=714 nm, τ≈422 ns) using 1.5 W of CW laser light. This state has enough internal energy to overcome additional reaction barriers, such as the one shown in FIG. 14A, resulting in a factor of ~10-30 increase in molecule number (see FIGS. 14B and 14C). Note that the resonant behavior of this reaction gives a strong systematic check that the molecules are radium-containing even in the presence of significant chemical contamination or spectral congestion. This method works to enhance production of RaOH, RaOD, and RaF, as well as BaOH and BaF, which were used as test and calibration species in this apparatus.

Atomic Ra densities inside the cell were measured via resonant optical absorption on the strong ¹S₀-¹P₁ line at 483 nm (τ~6 ns). Approximately 10¹⁰-10¹² cold Ra atoms were generated per ablation pulse. Each radium target yields about 0.5-2×10⁴ shots before being depleted, depending on the amount deposited and the deposition procedure (see FIGS. 5A-5D).

Molecular products were detected via laser-induced fluorescence from both pulsed and continuous wave (CW) lasers. An integrated lens in the cryogenic cell assembly collects light from a focal plane in the middle of the cell bore for real-time read-out via a low-noise photomultiplier tube (PMT) module. This detection presents several challenges: the constrained geometry results in significant light scatter from the various lasers off of surfaces; non-resonant scattering occurs off of gas-phase clusters and macromolecules created from ablation; and metastable excited states of various atoms and molecules created from the ablation emit broadband fluorescence. The cell was treated with low-reflectance surface coatings and detection of fluorescence at a different wavelength from any excitation laser so that scattered laser light can be blocked with optical filters. Resonant and non-resonant scattering were distinguished by scanning the laser frequencies to directly observe resonant behavior. Broadband background fluorescence was differentiated from laser-induced fluorescence signals by using amplitude-modulated lasers, typically in the 50-100 kHz range, combined with lock-in detection.

The lock-in detection approach also gives a useful tool to normalize against shot-to-shot fluctuations in atomic and molecular yield in a material-efficient way. By temporally interleaving two lasers (see FIG. 15) within each molecule pulse, one with a varying frequency for measuring a spectrum and the other having a fixed frequency at a known molecular resonance for signal normalization, one can monitor molecule production to reduce noise without needing to average many ablation shots. This method also verifies that any lack of spectral signal was not simply a result of poor molecule production due to ablation of a depleted target spot.

### Results and Discussion

Laser spectroscopy of RaOH and RaOD focused on the \tilde{X}²Σ⁺-\tilde{C}²Σ⁺ electronic transition, which approximately corresponds to the single sσ→pσ excitation of a valence, metal-localized electron. A probe laser excites \tilde{X}²Σ⁺(000)→\tilde{C}²Σ⁺(000), and fluorescence from the decay \tilde{C}²Σ⁺(000)→\tilde{X}²Σ⁺(v₁v₂v₃) was detected. Here (ν1ν2ν3) labels the number of quanta in the (Ra—O stretch, Ra—O—H bend, O—H stretch) vibrational modes, and the relative decay rates to each state are governed by the Franck-Condon principle. Because these molecules are predicted to be laser-coolable, the electronic and vibrational degrees of freedom are largely decoupled and the dominant decay is back down to (000). However, since that decay wavelength is the same as the intense probe laser, it was optically filtered so that only decays to excited vibrational states ν1=1 and ν2=2 are detected.

In order to efficiently find and explore the spectra given the large theoretical uncertainty and limited material, spectra were collected in phases with increasing resolution. The initial broadband CW survey spectroscopy for the RaOH \tilde{C} state was guided by prior relativistic coupled-cluster electronic structure calculations, which pointed to a search window on the order of 100 cm⁻¹ near 15750 cm⁻¹. An efficient search strategy was devised to scan over the full theory uncertainty range with a single 10 μCi radioisotope target. A spectrally broad (Δν~30 GHz~1 cm⁻¹) tunable CW laser was employed to scan for laser-induced fluorescence, which enabled coverage of the large area in only a few hours and a few hundred ablation shots. By using a CW laser, the full few-ms duration of the molecular pulse was utilized. From this initial survey data, a region of excess fluorescence at 15740 cm⁻¹ was located (see FIGS. 8A-8E), which was tentatively assigned as the \tilde{X}²Σ⁺→\tilde{C}²Σ⁺ origin system.

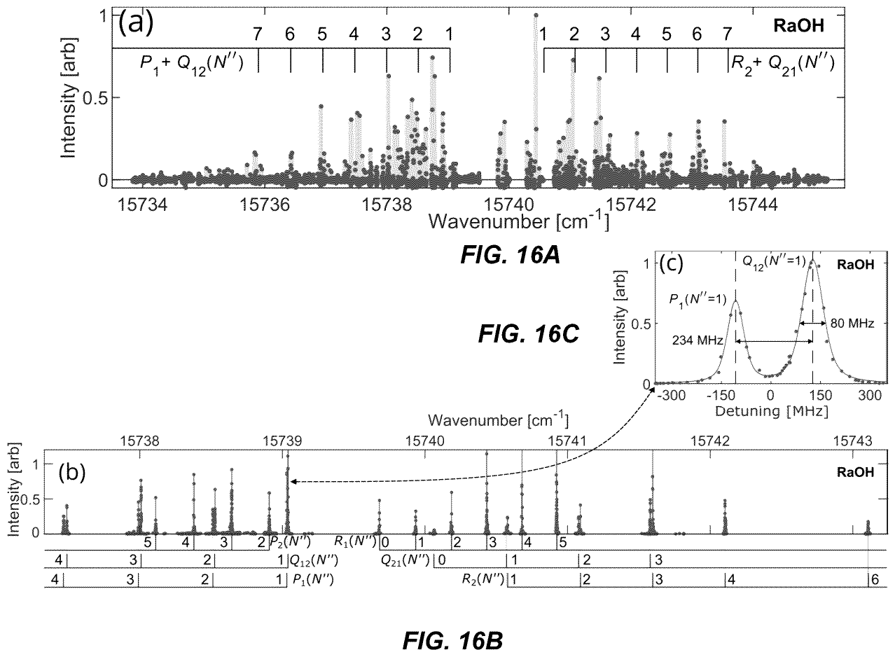

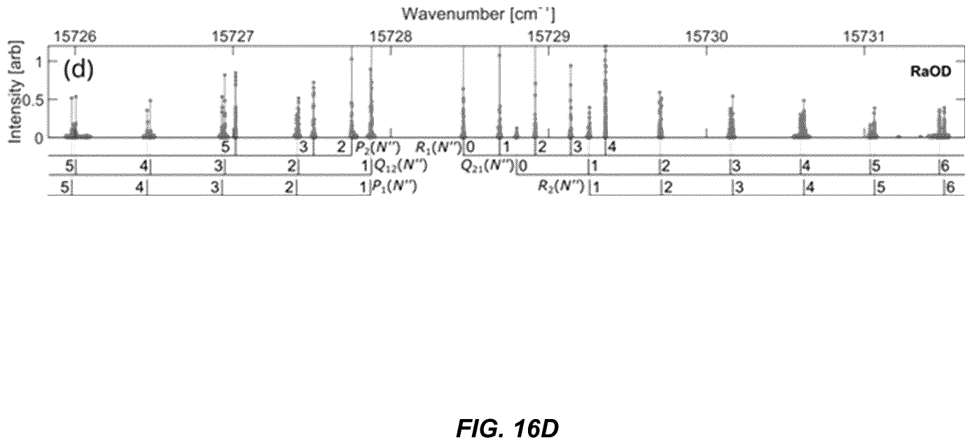

Subsequent scans with increasing resolution were performed over increasingly narrow regions. Medium resolution (Δν~2.5 GHz) pulsed dye laser excitation revealed a tightly bunched band head with isolated, rotationally resolved progressions in the wings, as depicted in FIG. 16A. The pulsed dye laser was operated with 50 kHz repetition rate, providing about 1,000 fluorescence pulses over the length of the molecular pulse. The clustered band head appearance, atypical for a highly diagonal Σ⁺-Σ⁺ band, was attributable to the large, negative excited state spin rotation of the \tilde{C}²Σ⁺ state, which pushes rotational R₁ and P₂ branch progressions towards the band origins. Without being bound by any theory, it is hypothesized that this was likely a consequence of large spin orbit coupling to the |Ω|=½ component of the Ã²Π electronic manifold that has been predicted to lie below the \tilde{C}²Σ⁺ manifold. Finally, individual lines were resolved at high resolution with a single-frequency (Δν~0.5 MHz) tunable CW dye laser, giving linewidths of about 100 MHz full width half maximum (FWHM) due to Doppler and natural broadening, and enabling the determination of line centers to ~MHz, as depicted in FIG. 16C and FIGS. 9A-9D.

A similar spectroscopic search was performed for the deuterated isotopologue RaOD, locating a band about 9 cm⁻¹ to the red of the main origin feature for RaOH. The finding was in reasonable agreement with electronic structure predictions for vibrational isotope shifts. The features at both bands show clear dependence on ablation of the (un)deuterated co-target as well as resonant pumping into the Ra ³P₁ state, indicative of optically driven chemical production (see FIG. 14B and FIG. 9D). Substituting H→D (or even H→T) should lower the bending vibration energy, thereby increasing the spontaneous lifetime of the symmetry-lowered “science state.”

Twenty-seven and thirty-two low-N lines on the RaOH and deuterated RaOD \tilde{X}²Σ⁺-\tilde{C}²Σ⁺ systems, respectively, were recorded via narrowband CW laser excitation. Here N is the angular momentum of the molecule not including electron or nuclear spin. A list of line centers determined via Voigt profile fit can be found in Table 4. Spin-rotation splitting was resolved for all lines down to the lowest N=1 rotational states. Hyperfine coupling from the proton and deuteron spin was expected on the order of ~1 MHz, which is below the present linewidth and therefore unresolved. In contrast to the severe perturbations observed in the first excited ²Σ⁺ state of BaOH, the low-N progressions into the \tilde{C}²Σ⁺ manifold in RaOH/D appear largely unperturbed. However, the intensities of some features and the excited state spin-rotation constants are indicative of spin-orbit induced mixing of the \tilde{C}²Σ⁺ state with adjacent states.

The complete RaOH/D high-resolution line lists were modeled and fit using a 5-parameter molecular fine-structure Hamiltonian with rotation (B₀) and spin rotation (γ), whose operator form can be written as:

$$\hat{H} = {B}_{0}^{″} {\hat{N}}_{g}^{2} + {γ}^{″} {\hat{N}}_{g} \cdot {\hat{S}}_{g} + {T}_{0} + {B}_{0}^{′} {\hat{N}}_{e}^{2} + {γ}^{′} {\hat{N}}_{e} \cdot {\hat{S}}_{e} \qquad ( 1 )$$

where the double and single primes as well as g, e subscript reference the ground and excited states, respectively, and T₀ is the excited state origin. The angular momentum matrix elements of this Hamiltonian are provided in the subsection D-Spectral Fitting above.

Rotational constants and deuterated isotope shifts for both the \tilde{X}²Σ⁺ and \tilde{C}²Σ⁺ states are in excellent agreement with bond lengths and moments of inertia calculated. A full set of extracted spectroscopic constants with ab initio theory comparisons are listed in Table 10. Good agreement is reached between observation and calculation of the ground spin-rotation constants, while a discrepancy exists in the magnitude of the excited state value. This suggests the influence of additional perturbations on the excited manifold from adjacent electronic states, which have been observed in similar systems but whose effects are not captured in the present electronic structure calculations.

TABLE 10
Fitted parameters for RaOH and RaOD. Theory values for band
origins (T₀) are taken from previously published data.

| RaOH | | | | | RaOD | | | | |
|---|---|---|---|---|---|---|---|---|---|
| (high- | \tilde{χ}² Σ_{1/2}⁺(000) | | \tilde{C}² Σ_{1/2}⁺(000) | | (high- | \tilde{χ}² Σ_{1/2}⁺(000) | | \tilde{C}² Σ_{1/2}⁺(000) | |
| res) | Measured | Theory | Measured | Theory | res) | Measured | Theory | Measured | Theory |
| T₀/cm⁻¹ | 0 | 0 | 15739.4220(2) | 15749 | T₀/cm⁻¹ | 0 | 0 | 15728.2246(2) | 15730 |
| B₀/MHz | 5814.3(7) | 5818 | 5780.3(6) | 5783 | B₀/MHz | 5256.3(6) | 5258 | 5208.9(6) | 5226 |
| γ/MHz | 151(3) | 165 | −7641(4) | −13574 | γ/MHz | 143(2) | 149 | −6739(3) | −12342 |

Theoretical values for rotational constants (B₀) and spin-rotation constants (γ) were obtained from relativistic exact two-component equation-of-motion coupled-cluster (X2C-EOM-CC) calculations. Values in parentheses are standard errors from fitting, while those in brackets are due to wavemeter uncertainties.

A medium-resolution spectrum of the analogous \tilde{X}²Σ⁺-\tilde{C}²Σ⁺ transition in RaF was recorded via pulsed dye excitation of the ν″=1→ν′=0 band system (see FIG. 17). Detection was performed on the strong ν′=0→ν″=0 decay via optical filtering. Similar to the RaOH data, isolated low-N features in the Q₂₁+R₂ and P₁+Q₁₂ progressions were resolved at the pulsed dye linewidth. As the ground state X²Σ⁺ parameters for RaF have already been determined, these features can be used to extract spectroscopic constants for the C²Σ⁺ state, which are listed in Table 11.

TABLE 11
Fitted parameters for the RaF C²Σ⁺ state compared
with X2C-EOM-CC calculated values determined above.

| (mid-res) | T₀/cm⁻¹ | B₀/MHz | γ/MHz |
|---|---|---|---|
| Measured | 16171.920(8) | 5663(6) | −12388(90) |
| Theory | 16199 | 5647 | −13443 |

T₀ is referenced to the X²Σ⁺(ν″=1)→C²Σ⁺(ν′=0) vibronic transition (see FIG. 17), whose theory values are from previously published data.

The results discussed herein demonstrate the successful production of cold gaseous phase atoms or molecules by utilizing the methods described herein. For example, by introducing a polyol into the sample solution before drop casting, a uniform distribution of target material was observed. The addition of the polyol suppresses the coffee ring effect and provides hundreds to thousands of ablation target spots before needing to move the laser focus. By fine tuning the additive and substrate combination, the drop-cast ablation targets can be tailored to the needs of the atom and molecule production. For example, the methods discussed above demonstrated successful production of gas phase atoms or molecules when a gold substrate was utilized in combination with a polyol and similarly when a porous or non-porous alumina substrate was employed without a polyol. The methods discussed herein are capable of turning microscopic amounts of starting material, in various chemical forms, into a consistent source for production of gaseous atoms and molecules. By varying the solution volume, additives, and substrates, the number of species created per shot, the number of shots, and the desired gas-phase products may be tailored by the user.

Furthermore, the cryogenic production and high-resolution laser spectroscopy of cold radioactive molecules, as well as the detection and characterization of the first neutral radium-containing polyatomic molecules was demonstrated, putting them in position to benefit from a wide range of modern quantum science tools. The methods developed herein are broadly applicable, establishing a new pathway for precision study of a wide range of radioactive species in a tabletop setting.

With the generation of cold samples, advanced spectroscopic techniques currently used on stable species to improve bandwidth and resolution of spectra are now applicable for the study of radioactive atoms and molecules. Broadband light sources in combination with high-optical-dispersion detectors can enable fast, multi-THz broadband spectral acquisition while preserving rotational and fine structure resolution.

Formation of molecular beams may enable laser cooling, which may be feasible in these species, and therefore open up a wide range of precision measurement applications. These molecules have the electronic structure for which many advanced optical trapping and precision measurement schemes have been both proposed and demonstrated. The methods described herein may be used for many radioactive systems, including molecular isotopologues containing the spinful, octupole-deformed ²²⁵Ra (I=½) and ²²³Ra (I=3/2) isotopes, which would enable highly sensitive searches for C P-violating hadronic physics at the frontiers of current experimental limits.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is a method of forming gas phase atoms or molecules, the method comprising: providing a solid material comprising a metal salt including radium, wherein the metal salt including radium comprises radium chloride or radium nitrate; dissolving the solid material in a solution comprising nitric acid, water, and xylitol to form a viscous mixture; drop casting the viscous mixture onto a gold substrate; heating the gold substrate to a temperature in a range of 80° C. to 120° C.; forming a film on the gold substrate by evaporating the water from the solution, wherein the film has a substantially uniform thickness and composition; positioning the film on the gold substrate in a cell including helium; cooling the gold substrate in the cell including helium to cryogenic temperatures; ablating a spot on the film on the gold substrate with a laser having a beam diameter in a range of 5 mm to 10 mm and a laser ablation energy in a range of 5 mJ/pulse to 50 mJ/pulse; and forming the gas phase atoms or molecules.

Example 2 is the method of example 1, wherein the xylitol concentration is from 1 mM to 10 mM.

Example 3 is the method of example(s) 1-2, further comprising repeating ablating the spot on the film on the gold substrate a predetermined number of times.

Example 4 is the method of example(s) 1-3, wherein the predetermined number of times is 50.

Example 5 is a method of forming gas phase atoms or molecules, the method comprising: providing a solid material; forming a viscous mixture comprising the solid material, a solvent, at least one acid, and at least one polyol; drop casting the viscous mixture onto a substrate; forming a volumetrically distributed mixture on the substrate; evaporating a liquid fraction of the solvent from the volumetrically distributed mixture to form a volumetrically distributed target on the substrate; ablating a portion of the volumetrically distributed target on the substrate with a laser; and forming the gas phase atoms or molecules.

Example 6 is the method of example 5, further comprising: positioning the volumetrically distributed target on the substrate in a cell including an inert gas; and cooling the substrate in the cell including the inert gas to cryogenic temperatures prior to ablating the portion of the volumetrically distributed target on the substrate.

Example 7 is the method of example(s) 5-6, wherein the solid material comprises an organic salt.

Example 8 is the method of example(s) 5-7, wherein the solid material comprises from 0.1 μg to 20,000 μg of a metal salt.

Example 9 is the method of example(s) 5-8, wherein the metal salt comprises radium atoms or barium atoms.

Example 10 is the method of example(s) 5-8, wherein the metal salt comprises barium atoms.

Example 11 is the method of example(s) 5-8, wherein the metal salt comprises radium chloride, barium chloride, radium nitrate, or barium nitrate.

Example 12 is the method of example(s) 5-8, wherein the viscous mixture comprises from 0.1 μg to 20,000 μg of the metal salt.

Example 13 is the method of example(s) 5-12, wherein the at least one acid comprises nitric acid or hydrochloric acid.

Example 14 is the method of example(s) 5-13, wherein a concentration of the polyol is from 1 mM to 10 mM, and wherein the polyol comprises xylitol, lactitol, sorbitol, erythritol, arabitol, ribitol, or a combination thereof.

Example 15 is the method of example(s) 5-14, wherein the polyol comprises xylitol.

Example 16 is the method of example(s) 5-14, wherein the polyol comprises lactitol, sorbitol, erythritol, arabitol, ribitol, or a combination thereof.

Example 17 is the method of example(s) 5-16, wherein the substrate comprises gold.

Example 18 is the method of example(s) 5-17, wherein the substrate comprises gold, aluminum hydroxide, copper, silica aerogel, porous alumina, quartz frit, a surface with electroplated gold, Inconel, Hastelloy, or silicon carbide.

Example 19 is the method of example(s) 5-18, wherein drop casting comprises adding from 0.5 μL to 5 μL of the viscous mixture onto a top surface of the substrate.

Example 20 is the method of example(s) 5-19, wherein the viscous mixture has a viscosity of from 1 to 10,000 mPa/s.

Example 21 is the method of example(s) 5-20, wherein the gas phase atoms comprise neutral atoms or atomic radium.

Example 22 is the method of example(s) 5-21, wherein the gas phase atoms comprise atomic radium.

Example 23 is the method of example(s) 5-22, wherein the volumetrically distributed target has a 3-dimensional shape having a dimension having a height along a Z-axis ranging from 0.01 μm to 10 μm, wherein the 3-dimensional shape is a cylindrical shape or an ovoid shape.

Example 24 is the method of example(s) 5-23, wherein the 3-dimensional shape is a cylindrical shape or an ovoid shape.

Example 25 is a method of forming gas phase atoms or molecules, the method comprising: providing a solid material; forming a viscous mixture comprising a solvent, and at least one acid; drop casting the viscous mixture onto porous alumina; distributing the viscous mixture throughout the porous alumina; evaporating the solvent from the viscous mixture to form a volumetrically distributed target inside the porous alumina; ablating the volumetrically distributed target with a laser; and forming the gas phase atoms or molecules.

Example 26 is the method of example 25, wherein the porous alumina has a porosity of greater than 30%.

Example 27 is the method of example(s) 25-26, wherein the solvent comprises water and the solid material comprises an organic salt or a metal salt, and wherein the at least one acid comprises hydrochloric acid or nitric acid.

Example 28 is the method of example(s) 25-27, wherein the metal salt is added to the viscous mixture in an amount of from 0.1 μg to 20,000 μg, and wherein the metal salt comprises radium chloride, barium chloride, radium nitrate, or barium nitrate.

Example 29 is the method of example(s) 25-28, wherein the solid material is added to the viscous mixture in an amount of from 0.1 μg to 20,000 μg.

Example 30 is the method of example(s) 25-29, wherein the at least one acid comprises hydrochloric acid or nitric acid.

Example 31 is the method of example(s) 25-30, further comprising: positioning the volumetrically distributed target on the porous alumina in a cell; and evacuating the cell to a pressure in a range of 1×10⁻⁴ torr to 1×10⁻¹³ torr.

A number of embodiments of the disclosure have been described. Nevertheless, it will be understood that various modification may be made without departing from the scope of the disclosure.

What is claimed is:

1. A method of forming gas phase atoms or molecules, the method comprising:
providing a solid material comprising a metal salt including radium, wherein the metal salt including radium comprises radium chloride or radium nitrate;
dissolving the solid material in a solution comprising nitric acid, water, and xylitol to form a viscous mixture;
drop casting the viscous mixture onto a gold substrate;
heating the gold substrate to a temperature in a range of 80° C. to 120° C.;
forming a film on the gold substrate by evaporating the water from the solution, wherein the film has a substantially uniform thickness and composition;
positioning the film on the gold substrate in a cell including helium;
cooling the gold substrate in the cell including helium to cryogenic temperatures;
ablating a spot on the film on the gold substrate with a laser having a beam diameter in a range of 5 mm to 10 mm and a laser ablation energy in a range of 5 mJ/pulse to 50 mJ/pulse; and
forming the gas phase atoms or molecules.

2. The method of claim 1, wherein a concentration of the xylitol is from 1 mM to 10 mM.

3. A method of forming gas phase atoms or molecules, the method comprising:
providing a solid material;
forming a viscous mixture comprising the solid material, a solvent, at least one acid, and at least one polyol;
drop casting the viscous mixture onto a substrate;
forming a volumetrically distributed mixture on the substrate;
evaporating a liquid fraction of the solvent from the volumetrically distributed mixture to form a volumetrically distributed target on the substrate;
ablating a portion of the volumetrically distributed target on the substrate with a laser; and
forming the gas phase atoms or molecules.

4. The method of claim 3, further comprising:
positioning the volumetrically distributed target on the substrate in a cell including an inert gas; and
cooling the substrate in the cell including the inert gas to cryogenic temperatures prior to ablating the portion of the volumetrically distributed target on the substrate.

5. The method of claim 3, wherein the solid material comprises an organic salt.

6. The method of claim 3, wherein the solid material comprises from 0.1 μg to 20,000 μg of a metal salt.

7. The method of claim 6, wherein the metal salt comprises radium atoms or barium atoms.

8. The method of claim 6, wherein the metal salt comprises radium chloride, barium chloride, radium nitrate, or barium nitrate.

9. The method of claim 3, wherein the at least one acid comprises nitric acid or hydrochloric acid.

10. The method of claim 3, wherein a concentration of the polyol is from 1 mM to 10 mM, and wherein the polyol comprises xylitol, lactitol, sorbitol, erythritol, arabitol, ribitol, or a combination thereof.

11. The method of claim 3, wherein the substrate comprises gold, aluminum hydroxide, copper, silica aerogel, porous alumina, quartz frit, a surface with electroplated gold, Inconel, Hastelloy, or silicon carbide.

12. The method of claim 3, wherein drop casting comprises adding from 0.5 μL to 5 μL of the viscous mixture onto a top surface of the substrate.

13. The method of claim 3, wherein the viscous mixture has a viscosity of from 1 to 10,000 mPa/s.

14. The method of claim 3, wherein the gas phase atoms comprise neutral atoms or atomic radium.

15. The method of claim 3, wherein the volumetrically distributed target has a 3-dimensional shape having a dimension having a height along a Z-axis ranging from 0.01 μm to 10 μm, wherein the 3-dimensional shape is a cylindrical shape or an ovoid shape.

16. A method of forming gas phase atoms or molecules, the method comprising:
providing a solid material;
forming a viscous mixture comprising a solvent, and at least one acid;
drop casting the viscous mixture onto porous alumina;
distributing the viscous mixture throughout the porous alumina;
evaporating the solvent from the viscous mixture to form a volumetrically distributed target inside the porous alumina;
ablating the volumetrically distributed target with a laser; and
forming the gas phase atoms or molecules.

17. The method of claim 16, wherein the porous alumina has a porosity of greater than 30%.

18. The method of claim 16, wherein the solvent comprises water and the solid material comprises an organic salt or a metal salt, and wherein the at least one acid comprises hydrochloric acid or nitric acid.

19. The method of claim 18, wherein the solid material is added to the viscous mixture in an amount of from 0.1 μg to 20,000 μg.

20. The method of claim 16, further comprising:
positioning the volumetrically distributed target on the porous alumina in a cell; and
evacuating the cell to a pressure in a range of 1×10⁻⁴ torr to 1×10⁻¹³ torr.
